(19) United States
(12) Patent Application Publication
(10) Pub. No.: US 2018/0197171 A1
(43) Pub. Date: Jul. 12, 2018

(54) SECURITY FOR ELECTRONIC TRANSACTIONS AND USER AUTHENTICATION

(71) Applicant: TENDER ARMOR, LLC, Wilmington, DE (US)

(72) Inventors: Robert J Steinman, Coral Springs, FL (US); Lester F Diaz, Weston, FL (US); Madeline K Aufseeser, Fort Lauderdale, FL (US)

(21) Appl. No.: 15/736,290

(22) PCT Filed: Jan. 6, 2016
(86) PCT No.: PCT/US16/12292

§ 371 Date: Dec. 13, 2017

Related U.S. Application Data
(60) Provisional application No. 62/215,409, filed on Sep. 8, 2015.

(51) Int. Cl. G06Q 20/38; G06Q 20/40

(52) U.S. Cl. CPC G06Q 20/385; G06Q 20/24; G06Q 20/40

(57) ABSTRACT

System and method for generating, disseminating, controlling, and processing limited-life security codes used to authenticate users, particularly for electronic financial transactions, such as payment transactions. Providing a user with a single security code usable across multiple accounts or other secured systems is contemplated, each security code having a limited lifetime. Each security code is a random number from a random number generator. The respective security codes for each user correspond to a respective security code validity period of limited duration. Thus, a table or matrix that associates the plurality of users with the respective sets of randomly selected security codes (each having their respective validity periods) is generated, and that matrix is provided to the respective entities to which each user requires secured access. In parallel, at least a current security code is provided to each user, and this is how the respective entities being accessed can track which code from which user is currently valid.

### FIELD OF THE INVENTION

The present invention most generally relates to user authentication as a prelude to engaging in an electronic transaction with an entity to which some form of access is desired. More particularly, the present invention relates to systems and methods for securing electronic transactions or other secured electronic access by use of a security code generated and managed as disclosed herein.

### BACKGROUND OF THE INVENTION

One example in which reliable user authentication is very important is in the field of electronic payment transactions.

Credit, debit and prepaid online card fraud is on the rise as is the volume of online shopping and third party bill payments. While new technology addresses “card present” fraud at merchant Point of Sale (POS) terminals via the use of EMV (Europay, Mastercard, and Visa—that, is “chipped” cards) and card terminal encryption, current security measures against the online “Card Not Present” (CNP) fraud problem are insufficient.

CNP fraud is large and growing in the U.S. Estimated fraud losses in 2013 for just credit card transactions are $2.8 billion, with double-digit growth expected for online fraud credit card purchases over the next 10 years, up to an estimated $6.4 billion by 2018.

Debit and prepaid card fraud worsens the dollar loss figures. As fraud increases so does higher financial institution (FI) expenses for fraud recovery, administration, and operations. Financial institutions also face cardholder frustration and potential loss of customers. The market implications are thus significant.

In addition, automated clearinghouse (ACH) debit payments are growing with virtual checks (Check Not Present) transactions on the rise. ACH debits are inexpensive, but with involve limited controls on the part of the account holder. Often the seller/merchant/payee is given broad (and often unlimited) permission to access an individual's checking account at the time of the consumer establishes a payment with the seller.

In the field of payment cards (including use in a CNP transaction), it is known to associate a short (usually 3 or 4 digits) numerical code with a payment card to increase confidence that a given payment transaction is being undertaken either with an authentic card in hand, or by establishing an indication (for a merchant or other payee) that card owner has the card in hand during a CNP transaction (for example, placed over the telephone).

There are several types of these conventional security codes.

A first type of conventional security code is commonly referred to as CVV1 (“card verification value”). This code is sometimes alternatively referred to in the art as CVC1 (“card validation code”). This code is invisibly encoded on the magnetic strip of the card and is retrieved when the card is swiped, for example, at a POS terminal belonging to a merchant during a card present transaction. It is conveyed as part of the transaction, and verified by the card issuer. Verification of the CVV1 code confirms that the payment card is actually being physically handled by the merchant (or other entity) who is swiping the card.

The CVV1 code as recorded on the card's magnetic strip is static, and also specific to a given payment card. If the card is physically duplicated and the magnetic strip data is copied, the CVV1 code would remain valid and usable, even by an unauthorized user.

A second type of conventional security code is commonly referred to as CVV2 (or sometimes CVC2). The CVV2 code is a fixed number printed on the payment card apart from the card account number (for example, on the back side on the signature strip, or occasionally on the front side separated from the account number). The CVV2 code is used for CNP transactions (such as telephone or online purchases of goods or services) and is intended to indicate that the person initiating the transaction has possession of the card or has seen a physical record of the card (with the CVV2 code thereon). Among other forms of misuse, the use of the CVV2 code helps prevent a situation in which the magnetic strip information is fraudulently copied (a relatively simple step, technically speaking) and thereafter used for CNP transactions. Most CNP transactions will require additional knowledge of the CVV2 code. By industry convention, the CVV2 code is not stored by merchants and payees during an electronic payment transaction. As a result, if transaction information (including, for example, customer payment card account numbers) is hacked or otherwise stolen from a merchant or payee, the information is less usable without knowledge of the corresponding CVV2 codes.

Like the CVV1 code, the CVV2 code is static (i.e., unchangeable for a given physical payment card), and is uniquely associated with that single payment card. Even though the CVV2 code is theoretically not retained (by convention or by express agreement between merchants and payment processors), bad actors who surreptitiously copy or retain the code cannot be avoided. It should be noted that, as conventionally utilized, the CVV2 code is plainly evident on the face of a payment card so as to be fraudulently usable if the card were stolen.

The use of Personal Identification Numbers (PIN) is also known generally, for example, in association with the use of debit cards. In a conventional example, the payment card is swiped to read account information off of the magnetic strip of the card, and the PIN is entered manually on a keypad or other input device by the user. A communication link is established with the bank or financial institution, permitting transmission of the card information and the entered PIN.

Conventionally, a given PIN code is usually associated with a single respective payment card or other electronic entity or system to which a user want to gain access. This further exacerbates the proliferation of individual security codes that a user must manage, remember, and keep secure (i.e., protect from loss and/or unauthorized access).

FIs, merchants, and consumers all desire a solution that reduces transaction risks, by minimizing fraud, reducing exposure to data breaches, alleviating brand reputational risk, and increasing control of when transactions occur, when and how they are authorized, and when monies transferred.

It is therefore desirable to find a security solution that addresses some of the problems in the conventional art: saving FIs and merchants money from unauthorized transactions or fraud losses; providing account holders with greater control over transactions; minimizing friction in the authorization process and completion of transactions; improving adoption of stronger security procedures.

FIs will not sacrifice market share, account holders and online purchase transaction volumes risking disintermediation (that is, the risk of losing a transactions to a third party interloper who may have built a more secure or different transaction methodology) of payment card or check transactions. Merchants want to minimize abandoned purchases, chargebacks and disputed transactions. A preferable solution would maximize utilization of existing processes, be easily integrated, scalable, and would not compromise authorization processing speeds.

An attractive solution would address needs of all of the parties to an online purchase transaction: FIs, cardholders, account holders and merchants. Preferably, such a solution would reduce CNP fraud, limit FI exposure, reduce fraud, dispute and chargeback expenses, and provide added benefits to cardholder and account holders.

### BRIEF SUMMARY OF THE INVENTION

Most generally, the present invention relates to systems and methods for user authentication in accessing and interacting with a secured entity to which the user desires access, particularly an electronic entity, such as secured computer networks or private or commercial website. However, the present invention can clearly be applied to systems for physical access by an individual to a secured building or the like. A particular aspect of the present invention relates to generation, dissemination, and management of security codes used for user authentication.

In a particular non-limitative example of the present invention, the present invention relates to systems and methods for increasing the security of a user authentication process in an electronic transaction, particularly, an electronic payment transaction, while also minimizing adoption burdens and maximizing user convenience in using and managing required security codes.

The present invention relies on a single limited-life randomized security code for user authentication which is usable across a range of modes of payment belonging to the user (such as credit cards, debit cards, checking accounts, etc.) instead of having several security codes each tied to a respective mode of payment. This conveniently reduces the number of security codes that a user must remember and protect.

At the same time, however, the security code has a limited life (for example, a single day) and is changed accordingly, which reduces the security exposure if the code is lost at any given moment. Also, the code can be easily changed if signs of fraudulent use and the like are detected, or particular accounts or payment modes (out of a plurality thereof) can be locked and unlocked selectively (or automatically) as may be needed in response to loss of a card or detection of limited fraudulent use (i.e., for certain accounts or payment modes.)

In an example of the present invention, a virtual matrix is generated in which a plurality of respective users (e.g., payment account holders) are associated with respective sets of randomly generated security codes. Each security code has a certain time period of validity, with no overlap (or with minimal overlap, as explained below) of validity with the other security codes in the set associated with the given user. A current (with respect to users and/or the current set of security codes) version of the matrix is periodically distributed to payment processors or financial institutions so that it can be referenced for authentication. In parallel, at least a currently valid security code for a given user is conveyed to that user.

In a particular example of the invention, the information on the matrix (particularly, the security codes) is mathematically obfuscated (for example, using a hash function) before the matrix is distributed to respective payment processors. Preferably, the method of obfuscation is unique to each payment processor, such as by way of using a unique respective hash salts for each payment processor.

In practice, a request to process an electronic payment transaction is received by a relevant payment processor along with one of the security codes for authentication of the allegedly authorized user initiating the electronic payment transaction request. The received security code is compared by the payment processor with the security code in the current matrix corresponding to the allegedly authorized user, for the validity period corresponding to the time of the request to process the electronic payment transaction. The transaction is approved or disapproved depending on the comparison.

### BRIEF DESCRIPTION OF THE DRAWINGS

The present invention will be even more clearly understood with reference to the drawings appended hereto, taken in combination with this written description, in which:

FIG. 1 is a high-level schematic illustration illustrating the interconnections between the various “players” in an electronic payment transaction and the hardware placements associated therewith;

FIG. 2 illustrates a process of generating groups of security codes according to the present invention, including the interactions related thereto between various payment processing entities;

FIG. 2A illustrates an example of how a Temporary Known Random Patterns matrix is generated;

FIG. 3 illustrates a process of initial registration of a user in order to use the present invention;

FIGS. 3A-3H illustrate a variant of the registration process that includes grouping various accounts or other implementations requiring a security code so as to have a security common to all;

FIG. 4 illustrates a process of conveying a security code according to the present invention to a user;

FIG. 5 illustrates steps of an electronic payment using a credit or debit card or a check, using the security code of the present invention;

FIG. 6 illustrates further steps of authorizing an electronic payment transaction;

FIG. 7 illustrates further steps of validating a security code being submitted, within the framework of FIG. 6;

FIG. 8 illustrates steps of recording and analyzing transaction results, within the framework of FIG. 6;

FIG. 9 illustrates a process of sending a notification to a user, which process is used as part of several other processes of the present invention;

FIG. 10 illustrates a process of selectively locking or unlocking a financial account associated with the present invention;

FIG. 11 illustrates a process of sending notifications to payment processors or financial institutions; and

FIG. 12 illustrates a process of validating an electronic payment transaction.

### DETAILED DESCRIPTION OF THE PRESENT INVENTION

It is to be understood that details of the various aspects of the present invention disclosed herein are specifically meant to be applicable to the broad concepts of the present invention in various combinations to the fullest extent possible, even if the absence of specific language herein to that effect.

For the purposes of the present disclosure, the following definitions are generally intended, as may be further modified herein.

An “account” is any financial relationship that stores and can move funds for the purpose of buying and selling goods and services. Typically, accounts can include but are not limited to: checking, savings, lines of credit, credit cards, debit cards, prepaid cards (including payroll, gift, & rewards), digital wallets, private-label ACH card, decoupled debit card, with or without a virtual or physical Card or Check used to make purchases, electronic fund transfers (EFT), or funds transfer by other means.

A “transaction” is the movement of money, whether between businesses, households, individuals, governments, and other public or private organizations, conducted over computer-mediated networks that may occur on or off-line.

A “payment processor” refers to an entity that receives an electronic payment request and acts as an intermediary that checks details of the electronic payment request and handles the movement of funds from the relevant financial institution (such as a card-issuing bank) to the merchant or payee. The payment processor, as indicated, can be, for example, a Card Payment Processor or a Receiving Depository Financial Institution or Bank. It is also meant to encompass the Automated Clearing House (ACH) and the Federal Reserve to the extent they are involved in payment processor activity. However, for the sake of simplicity of the disclosure herein, the term “payment processor” will be principally used in this context, without intending to be limitative in the context of this explanation.

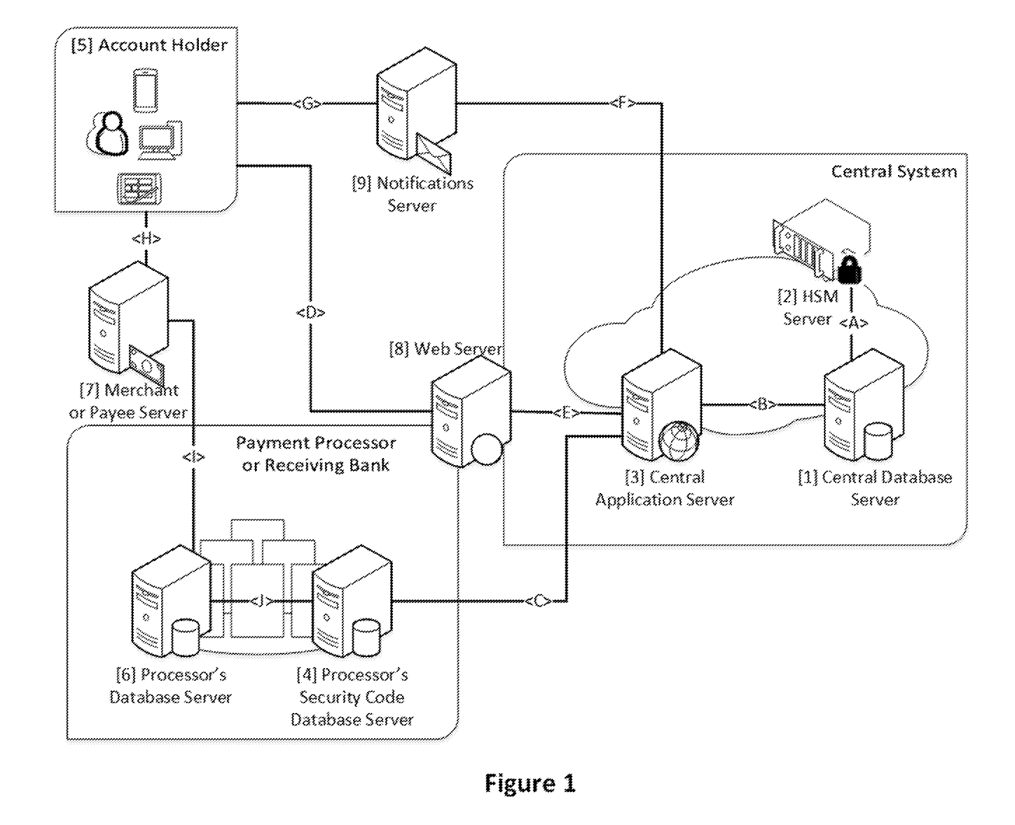

FIG. 1 schematically illustrates a system for carrying out electronic payment transactions, into which the present invention is integrated.

The main elements illustrated in FIG. 1 may be directly or operably in communication with one another. To be in “operable communication” with another element is intended to encompass the possibility of intervening elements in the communication pathway between two elements, even if such intervening elements are not necessarily expressly indicated. The illustrated “groupings” of elements (such as in the “central system”) are schematic in the sense that they are not meant to require any degree of physical proximity (within the limitations of conventional networking principles), although proximity is certainly permissible. Also, the communication “links” between the elements in FIG. 1 are intended to reflect the general interrelationship of the elements and are not meant to be limitative, or, particularly, exclusive (i.e., other communication links not illustrated in FIG. 1 may exist between the illustrated elements).

A “central system” as indicated in FIG. 1 includes elements carrying out a principal part of the operations according to the present invention. Central database server 1 is a data repository hosted in, for example and without limitation, a dedicated or virtual hardware system, held in the Cloud or in on-premises datacenters, which centrally holds supporting data for the present invention, including: account holder enrollment profiles and their corresponding information and preferences, such as notification preferences or conditional transaction rules or Account locking preferences; the generated security codes (sometimes referred to herein as Temporary Known Random Patterns), generated as explained hereinbelow, in order to distribute them out to participating Payment Processors, as well as to notify enrolled account holders of their current security code active for all of the accounts registered in the account holder's Profile; and information about the transactions attempted on registered accounts. An example of the central database server 1 is the Amazon Relational Database Service (sometimes referred to as Amazon RDS), which allows creation and operation of a virtual server on a remote system. An implementation on a physical server would also be effective according to the present invention.

A Hardware Security Module (HSM) 2 may be held in the Cloud or on-premises, and is used to securely generate, store, and manage the cryptographic keys used to encrypt or hash sensitive information generated and processed in the course of operation according to the present invention. It may also be used for true random number generation to populate the security code matrix (i.e., the matrix that associates users with respective sets of security codes, where each individual security code has a respective time period of validity), as explained below. A commercially available implementation of an HSM 2 is available from, for example, Amazon Web Services, and is based on, for example, Luna SA 7000 HSM appliances from SafeNet, Inc., using the Luna SA software (version 5). “True” random number generation, as is known in the art, relies on scientifically random physical phenomena (such as atmospheric noise detected by a radio receiver, or radioactive decay) to maximize the randomness of the numbers generated, and is thus the preferred approach for use in the present invention.

A central application server 3 is a middle-tier application server or collection of servers, held in the Cloud or On-Premises, dedicated to efficiently execute the functions and procedures that implement the business logic of the system. (“Middle-tier” refers generally to an application server that performs the business logic of the application and is operationally situated between the user interface or webservers, and the database server(s) as part of a multi-tier architecture.) It holds the frameworks necessary to execute these software modules, and connects to the central database server 1 to support necessary data-centric operations. It also hosts API (Application Program Interface) calls for outside clients or vendors to communicate with the central database server 1 in order to manage account holder enrollments, account holder preferences, or to receive transaction information from Processors (or Issuer or Financial Institutions). For the purposes of these process descriptions, it is also responsible for connecting outbound to other vendors to transmit files or data payloads to fulfil different application features such as B2B (Business-to-business) communications, or account holder notifications through a Notifications server 9, (for instance, Email Exchange servers, SMS Aggregators, mobile applications push alerts services, or web services providers that aggregate all or some of these services together, for example the Amazon Simple Notifications Service as part of Amazon Web Services solution). Some of these functions could also be implemented in separate hardware systems for a deeper, more distributed multi-tier architecture. A commercially available example of the central application server 3 is the Amazon Elastic Compute Cloud (sometimes known as the Amazon EC2), though a physical server implementation would also be appropriate according to the present invention.

At the example “payment processor” as indicated in FIG. 1 (or similarly situated financial institution involved with electronic payment processing), one or more database servers 4, 6 are provided, which in turn handle and process a plurality of various databases. Generally, the payment processor will already possess one or more database servers (and databases running thereon) for performing conventional operations. Certain operations at the payment processor according to the present invention are also database server-resident, and can either be implemented on existing hardware, or if desired, can be implemented on an independent database server (or servers). With appropriate connectivity, the required implementation does not need to be local to the payment processor, and could be located, for example, local to the central system, or at another physical location. With this as context, the present disclosure of the present invention will, for the sake of simplicity and clarity of disclosure, make mention by way of example of two servers associated with the payment processor, as if they were physically independent units. However, all of the foregoing considerations apply to the present invention, and the functionality attributed to one database server, as described herein, can be implemented in the other database server.

Accordingly, the payment processor may have a security code database server 4 according to the present invention may be provided that is in communication with the central system (i.e., including central database server 1, HSM 2, and application server 3). A commercially available example of the security code database server 4 is the Dell 13G PowerEdge R730xd. Security code database server 4 represents an instance of the data repository containing the necessary data and procedures to permit participating Payment Processors to complete transactions according to the present invention, including the validation of the security codes generated according to the present invention and entered by enrolled account holders while performing an electronic payment transaction. These instances could be embodied in a separate hardware system, dedicated or virtual, in the Cloud or On-Premises, or inside an existing database instance on the Payment Processor's existing database server (i.e., integrated into the payment processor's pre-existing equipment). The payment processor also will usually have one or more of its own pre-existing database servers 6. Database server 6 is generally a data repository owned and/or operated by the participating Payment Processor or Financial Institution, hosted in a dedicated or virtual hardware system, held in the Cloud or On-Premises Datacenters, which contains the data and methods necessary to process transaction authorizations generally (i.e., whether or not according to the present invention).

A representative account holder (or, in other words, a customer having one or more financial accounts and who is seeking to pay for goods or services or the like via an electronic payment transaction) is illustrated at 5. Typically, accounts can include but are not limited to; checking, savings, lines of credit, credit cards, debit cards, prepaid cards (including payroll, gift, & rewards), digital wallets, private-label-ACH card, decoupled debit card (i.e., an account issued by one entity but linked to an account (usually a funding source) associated with another entity), with or without a virtual or physical card or check used to make purchases, electronic fund transfers (EFT), or funds transfer by other means. In particular, with respect to payment cards, the present invention is meant to apply to open-loop, closed-loop, single load, and reloadable cards. As is known in the art, an “open loop” payment card refers to card types having general acceptance among merchants (such as Visa®, American Express®, etc.) whereas “closed loop” payment cards is restricted to a limited merchant network or group of merchants (such as department store-issued credit cards).

The account holder 5 may from time to time complete a financial transaction, particularly, an electronic payment transaction. A “transaction” is the movement of money, whether between businesses, households, individuals, governments, and other public or private organizations, conducted over computer-mediated networks that may occur on or off-line.

The account holder 5 may initiate a desired financial transaction from a personal electronic device, such as, without limitation, a desktop or laptop computer, tablet computer, smartphone, cell phone, or any other portable or affixed device. Alternatively, the transaction can be conducted via a “live” customer service agent (by phone or face-to-face).

An appropriate interface for interacting with the system of the present invention may include a web site, a mobile or desktop application or applet, or text messages, that connects with and issues direct or indirect calls to an Application Programming Interface (API) hosted at central application server 3 in order to (by way of example): manage enrollment profile and preferences according to the present invention, including notification preferences or conditional transaction or account locking preferences; receive alerts and notifications according to the present invention regarding transactions, enrollment profile changes, or to get a current security code according to the present invention; initiate a request to manage an account status or system behavior, such as permanently or temporarily, entirely or conditionally locking an account from participating in transactions, or to advise an issuing bank of international travel, or that a payment card or device has been compromised, damaged, lost, or stolen.

The account holder 5 may from time to time interact with a merchant (or payee) 7, or an intermediate billing entity (not illustrated) to make a purchase or other payment transaction and submit a transaction authorization request. The transaction authorization might include: a Customer Not Present transaction authorization request (for example, a Card Not Present transaction) performed on a web site, mobile, or desktop application, or through voice communication (e.g., on the phone with a live agent, or an automated voice-recognition system), or through a device that communicates the transaction information to the Merchant or Payee 7 by using a biometric scan, like a fingerprint or voice-recognition or retinal scan; or a Customer Present transaction (for example a Card Present transaction) where the account holder 5 personally presents the Merchant (or Payee) 7 with a payment card, check, device, chip, or any representation of a financial account with which to make a purchase or payment.

A merchant (or payee) 7 for the purposes of the present invention is any entity that accepts payment methods such as debit, credit, check, or ACH, for example, by way of a device or application used to complete a card transaction authorization initiated by the account holder 5. This could be represented by a web application, or mobile application installed on a device which the account holder 5 has access to or otherwise operates. It could also be a physical device at the merchant location (like a Point of Sale terminal) with which the account holder enters the transaction information by typing or scanning the information contained on a Card or a physical or virtual representation thereof, or by scanning account holder's biometrics, to name a few examples. In a certain example of the present invention, the merchant 7 may operate, for example, an HP Moonshot ProLiant m350.

One or more additional web servers 8 may be needed according to the present invention, for example, to host a Website or Web Application to interface with account holder 5. The above-mentioned example of the Amazon EC2 could also be used here. A Web server 8 could be located within the central system, in the Cloud, or at an On-Premises Datacenter. The web server 8 could alternatively be a part of the local network of the Payment Processor. The functionality may also be provided by third-party entities hosting applications, websites, or APIs to receive input from account holder 5 to manage enrollments, and to present account holder 5 with enrollment and other relevant information, such as the current security code according to the present invention.

Finally, a notification server 9 (for example, and without limitation, an HP Moonshot ProLiant m800) may be any server that serves as an intermediary to deliver or push notifications to the account holder 5. Some examples of such servers or group of servers could be Exchange servers to process and deliver Email messages, or an SMS Aggregator's server to process and deliver SMS text messages to a cell phone belonging to account holder 5, or a web services provider that aggregates all or some of these services together (e.g., the Amazon Simple Notifications Service within the Amazon Web Services solution).

The following is an overview of the server interactions/connections represented in FIG. 1. Many will be discussed in more detail with respect to specific explanation of various processes according to the present invention.

<A>: The central database server 1 issues calls to the HSM 2 APIs, for example through a SQL CLR Assembly, in order to retrieve true random numbers from a hardware-based true random number generator (RNG), or to securely store and retrieve cryptographic keys to hash or encrypt sensitive information, such as security codes generated according to the present invention.

<B>: The Central Applications server 3 connects to the central database server 1 in order to submit account holder enrollment changes, or to update transaction information received from the Payment Processors, or to retrieve information to either send notifications to account holders, or update Payment Processors with relevant information such as account holder enrollment changes or new security codes (Temporary Known Random Patterns).

<C>: The Central Applications server 3 in this case communicates with a payment processor's database server 4, possibly through one or multiple tiered servers within the Processor's network, to update the Processor's database server 4 with account holder enrollment changes, or new security codes (Temporary Known Random Patterns), or to retrieve information collected by the payment processor, or changes produced within the Processor's database server 4 and store it on the central database server 1.

<D>: An account holder 5, through one or many of the communication means used by the account holder (e.g., a desktop or laptop computer, a smartphone, or a portable tablet computer) interfaces with web applications hosted within an instance of Web server 8 in order to create, delete, or modify enrollment profiles or user preferences, and to retrieve information from the system such as the current security code.

<E>: The information (e.g., enrollment changes) collected by Web server 8 is transmitted via API calls to the Central Application server 3. Web server 8 also issues API calls to Central Application server 3 to retrieve and present information from the system to the account holder 5.

<F>: The Central Application server 3 connects to a Notification server 9 in order to push alerts to the account holder 5, such as the current security code, or information about activity and transactions involving the Accounts registered under the account holder's enrollment profile.

<G>: A Notifications server pushes alerts such as Email messages, SMS text messages, or mobile application push alerts to the account holder 5.

<H>: An account holder interacts with a Merchant or Payee 7 interface either remotely, such as via a merchant's web site, via a mobile or remote application installed on a portable device such as a smartphone, a tablet, or a watch, via an automated phone system or live agent, or via a physical terminal at a merchant location, in order to conduct a payment transaction for goods or services.

<I>: A Merchant or Payee 7 sends, through applicable networks and channels, transaction information submitted by account holder 5 to be processed by Processor's database server 6 for approval or rejection.

<J>: The Processor's database server 6, in the case of transactions that can be conducted according to the present invention, communicates with Processor's security code database server 4 in order to validate a security code according to the present invention that is entered as part of a transaction authorization request. Processor's database server 6 could also communicate transaction information to Processor's database server 4, or Processor's security code database server 4 could send information received by account holder 5 or generated by Central Application server 3 to Processor's database server 6.

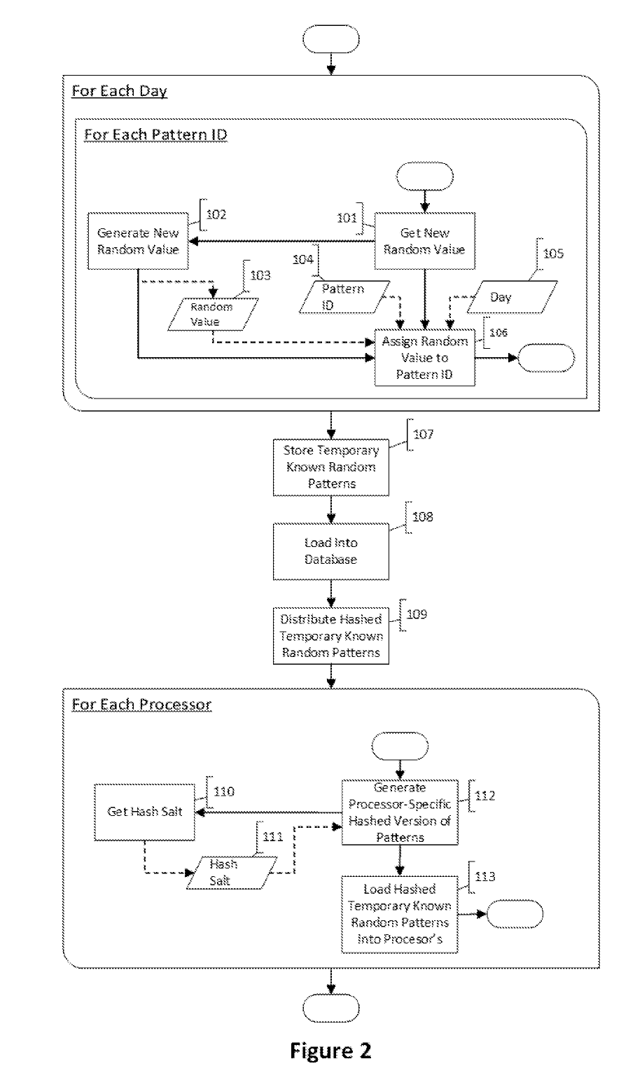

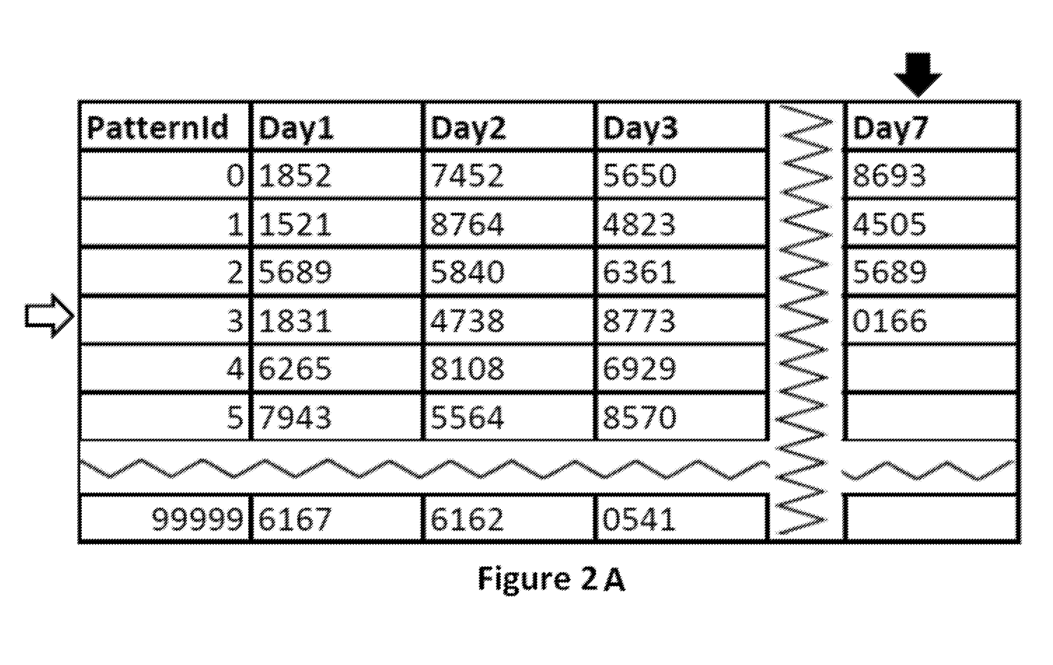

FIG. 2 illustrates a process of generating security codes according to the present invention, and in particular, a process of generating a combined matrix associating a plurality of account holders 5 (sometimes referred to herein as “users”) with respective sets of several security codes. (For the purposes of this disclosure, each set of security codes may be sometimes referred to herein as, variously, “patterns” or “random patterns” or “temporary known random patterns.”) In a particular example of the present invention, the respective security codes are mathematically random numbers that have a limited life time or validity period (usually, but not necessarily, on the order of days or hours). The random numbers are preferably generated by a true random number generator (as is known in the art) to maximize unpredictability in the sequences of security codes being generated.

In a further aspect of the present invention, the respective validity periods of the security codes are temporally sequential, so that in effect, after one of the security codes expires, there is a “next” security code (time wise) that can be used by the account holder. The validity periods may be purely sequential substantially without any temporal overlap, but it can be useful to build in a relatively small (in comparison with the length of the validity period) temporal overlap (for example, a one-hour overlap where the time period of validity is one day) between the end of one validity period and the start of the subsequent one. That is, one security code may remain valid for a short time during the start of validity of the “next” security code. The reason for providing this overlapping validity is to avoid any customer (i.e., user/account holder) annoyance or frustration if a transaction is entered a short time prior to the end of one validity period (for example, at 11.30 p.m. where the end of the validity period is on a daily basis at 12 midnight), and there are unforeseen delays in information exchanges or other processing as disclosed herein that delay actual treatment of an electronic payment until after 12 midnight, which would theoretically require submission of the account holder's subsequent security code. The relatively short overlap is meant to balance assuring convenience of use for the account holder on the one hand, while minimizing the security risk of having more than one security code pending as valid at one time.

The generation of a new matrix, as depicted in FIGS. 2 and 2A, is initiated on the central application server 3 (for example, by way of a software job application run on a scheduled frequency). For the purposes of this non-limitative example, a daily operation is assumed, but it could be scheduled to run several times during a day, or less often than daily (e.g., once every three days, for example).

The matrix according to the present invention in a general sense groups users or other individuals who require security code-protected access to use or otherwise have access to an electronic entity. In general, a given matrix includes all of the users/customers/payors/etc. who are associated with a given payment processor (for example, all of the payment card holders associated with that payment processor) who participate in the system according to the present invention. Additional sets of security codes may be generated as a kind of spare, available as may be needed to replace originally assigned sets of security codes (for example, in case of detected fraudulent activity). However, because of the nature of the invention as disclosed herein, it is also within the scope of the present invention to associate more than one user with a given set of security codes, as will be discussed further below.

Again, for the purposes of illustration, the present invention is principally described herein in the context of authentication for electronic payment transactions, but it can be applied to other kinds of electronically authenticated access to electronic entities, such as private networks, government agency websites, etc.

In general, the matrix is first populated by random numbers to define respective sets of security codes in which the respective security codes in a given set each have a specific limited validity period, such as an hours-long time period during one specific day, or a specific calendar day. Each of the sets of security codes is associated with a unique identifier. Once the matrix is populated in this manner, users are associated with one of the unique identifiers (referred to as a pattern ID herein) so as to be associated with the set of security codes that matches that identifier. On this basis, a given user at a given moment is associated with a specific set of security codes, and a currently valid code that the user should use for authenticating transactions can be identified relative to the applicable validity period (for example, a certain calendar day).

The security code generation process preferably cycles through all of the pattern IDs for a given validity period and assigns a new random number value (of predetermined length, such as 4 digits) to each Pattern ID for that validity period. It then moves on to generate a second set of random values for all of the respective pattern IDs for a next validity period, one by one, before moving on to generate a third, fourth set, and so on.

In other words, the matrix is preferably assembled by generating a random number for each of the different pattern IDs, and not a complete set of random numbers for a first pattern ID, then a complete set for the second pattern ID, then the third, fourth, fifth, etc. As a result, if by chance there is any kind of identifiable predictability to the sequence of random numbers generated by the random number generator (in the HSM 2, for example) being used, the predictability will be spread among different users and not within the set of random numbers for a single user. This is illustrated below with reference to FIG. 2A.

As seen in FIG. 2, the first step in this random number generation for each iteration is to get a new random value 101 from an RNG, such as a Hardware Security Module (HSM) 2. HSM 2 desirably provides a true RNG, but any other kind of RNG, hardware or software based, including a pseudo-random number generator, could be used for this purpose. For instance a Web Service that provides true Random Numbers, or a third-party binary application providing an interface to a software or hardware-based algorithm to generate random numbers, or a database engine could be used as well.

The RNG on HSM 2 produces a new Random Value 103, which is assigned at step 106 to the Pattern ID 104 of the current iteration corresponding to, for example, the Day (or any other desired time period) 105 of the current iteration. This example generates one Random Value 103 for each Day 105 for each respective Pattern ID 104. However, multiple Random Values could be assigned to each Pattern ID which may or may not be tied to a particular day or period of time, or could be associated with a time period shorter or longer than a day. Random values could also be associated with a specific process identifier, or a frequency of occurrence of a certain event or process. As schematically indicated in FIG. 2, the process of generating random values 103 is iterative, at a first level for the series of pattern IDs, then incremented to the next validity period (here, by way of example, the validity period is a day).

FIG. 2A is a schematic representation of a matrix according to the present invention illustrating a preferred process of populating the matrix. The left hand column contains pattern identifications (IDs) (simplified as ranging from 0 . . . 99999), which are each associated with a set of random number security codes (row-wise). Here, for example, each random number for each pattern ID is on a day-by-day validity basis (Day1, Day2, Day3, etc.). For each day column indexed by the primary cursor (the dark downward arrow at the column for “Day 7,” the secondary cursor (here, for example, at the row corresponding to pattern ID 3) moves through each pattern IDs in order to populate the next randomly generated security code (corresponding to the “For Each Pattern ID” grouping of steps in FIG. 2). Thus, in FIG. 2A the last generated code is 0166 at (PatternId 3; Day7). The secondary cursor will then move to the next PatternId (i.e., 4) and generate a new random code for (PatternId 4; Day7), and so on, for all of the pattern IDs in the matrix for Day7, then the primary cursor will advance to the next day column (i.e., Day8) (corresponding to the next level of iterations in FIG. 2 indicated by “For Each Day”), and the random number assignment will repeat. As a result, as mentioned above, if the set of randomized security codes for any given user (i.e., for any given pattern ID) is misappropriated, any patterns or lack of randomness in the random number generation that may occur will not be evident in the row-wise direction.

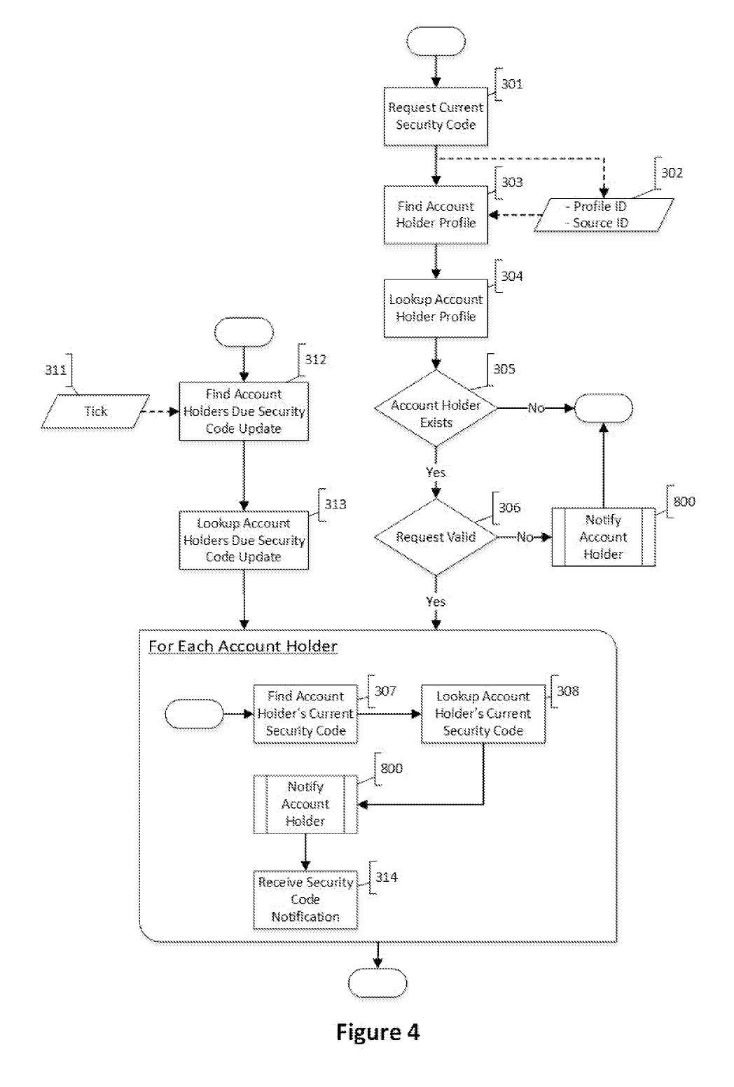

It will be noted that more patterns (i.e., sets of security codes) could be generated for the matrix than there are customers/users. This can permit “spare” sets of codes to be available, for example, for use by a customer as a replacement set of codes if an initial set of security codes appears to be compromised. For example, see the disclosure below relative to FIG. 4 with respect to reassignment of a new pattern ID.

However, a situation in which fewer patterns are generated than there are customers/users can also be contemplated in accordance with the present invention. In such a case, more than one user might be associated with a given pattern ID. Even though, for example, two users might therefore, strictly speaking, know the other's security codes, the security risk is still low because as a practical matter, it would be highly unlikely that either user would know in general that he is “sharing” his set of security codes with another user, and even more unlikely that he would know which user specifically has a set of security codes in common, bearing in mind that the assignment users to pattern IDs is effectively opaque to the users.

Generation of these random values could be optionally cross-referenced or otherwise compared to a list of values to be excluded from the matrix. For instance, certain culturally-offensive or otherwise sensitive values may be excluded (such as “13” in western cultures, or “4” in some eastern cultures). As may be needed, a RNG-generated value would be checked against the exclusion list and, if found, a new call to the RNG is made to generate a replacement value, until the value generated is not on the exclusion list.

Once the complete matrix of security codes (Temporary Known Random Patterns) is populated, it is then sent to be stored at step 107 on central database server 1 which loads the matrix at step 108 into a database table, in this example. The matrix could also be stored in other formats, such as in a file system, or a pictographic representation.

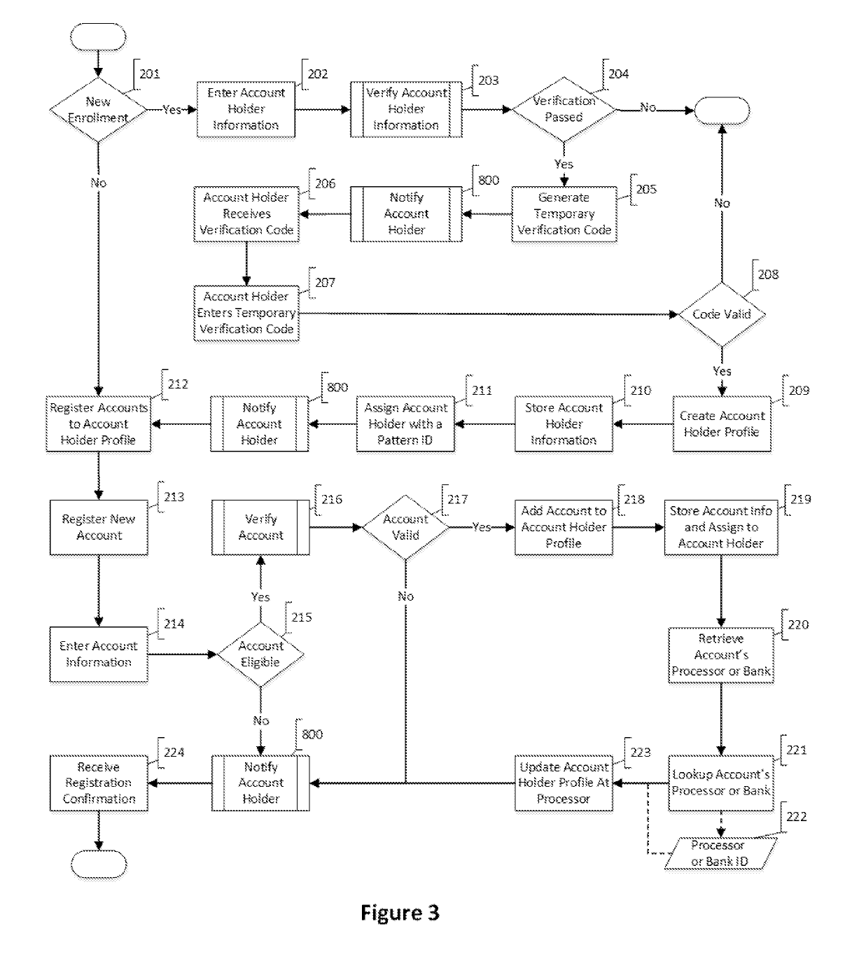

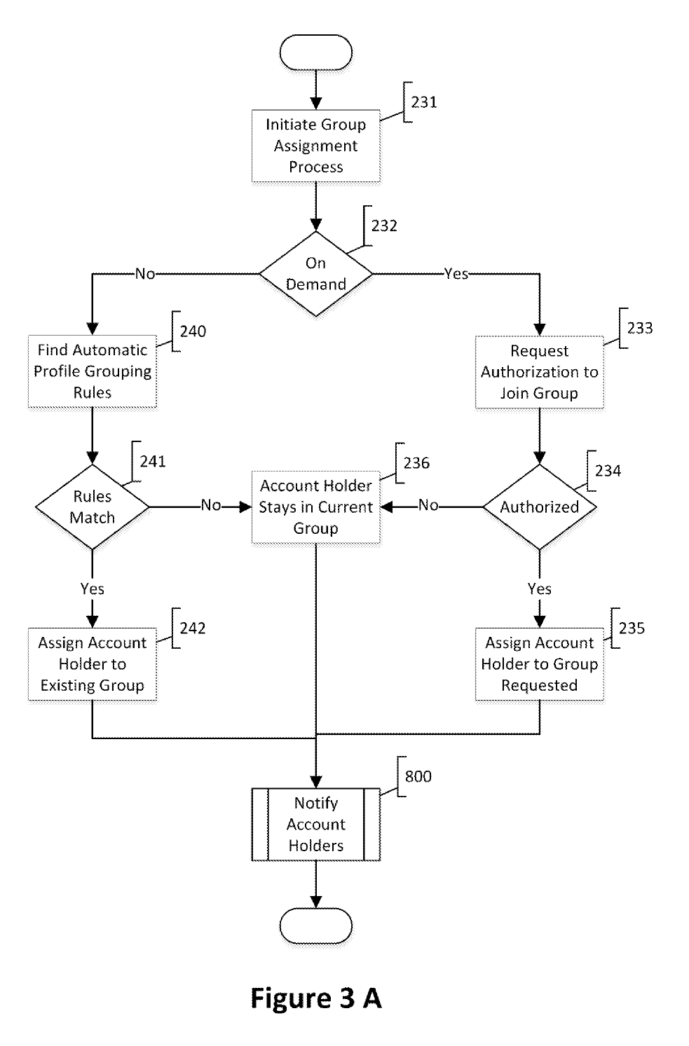

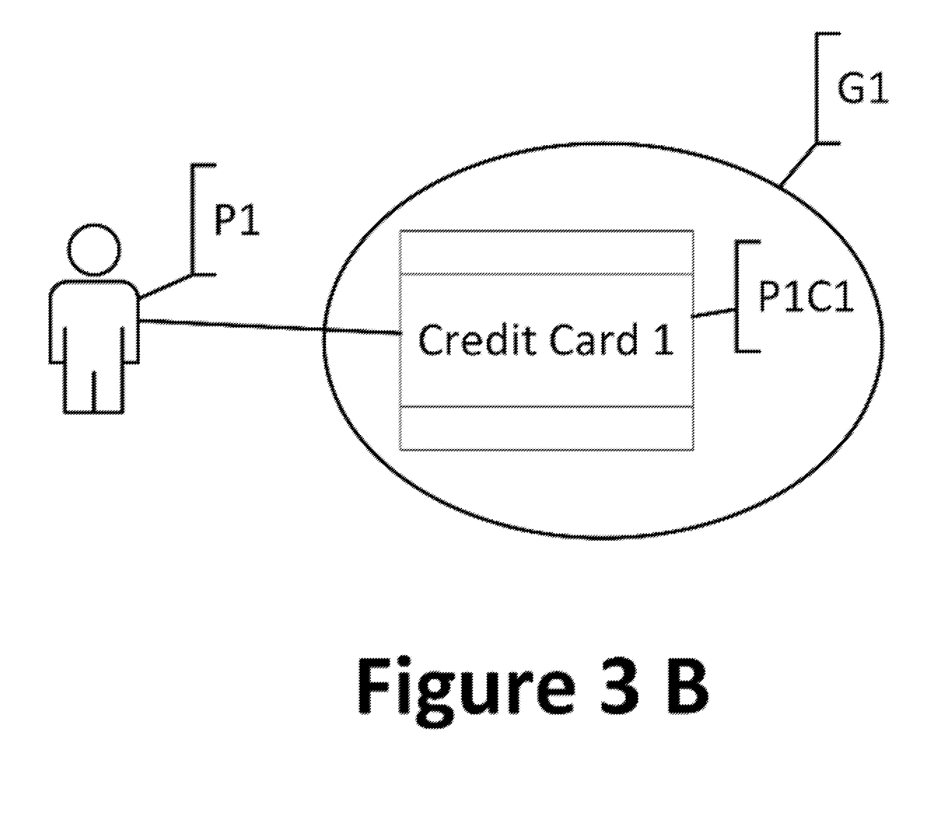

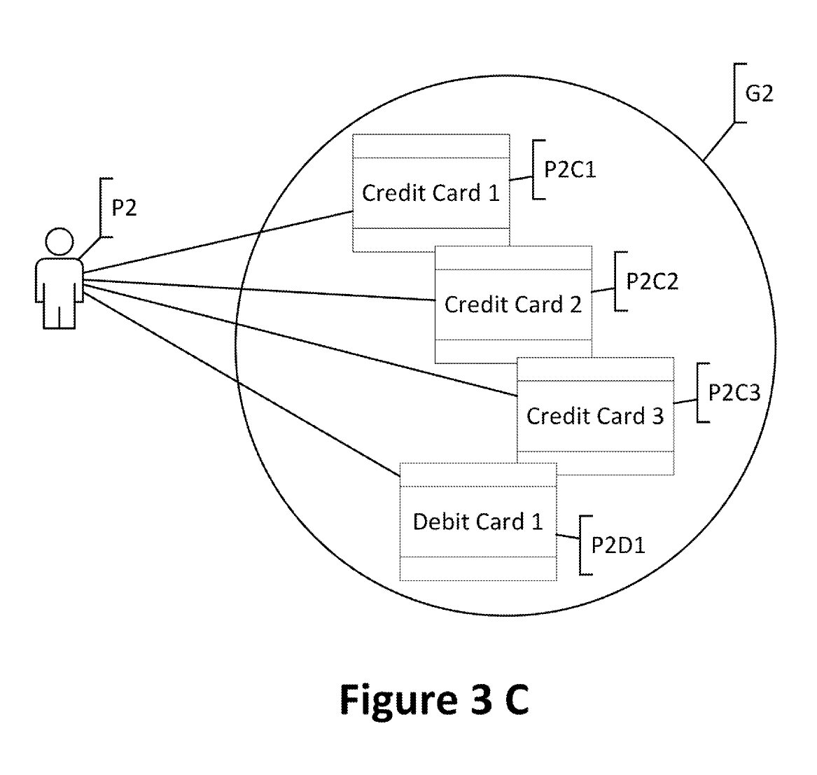

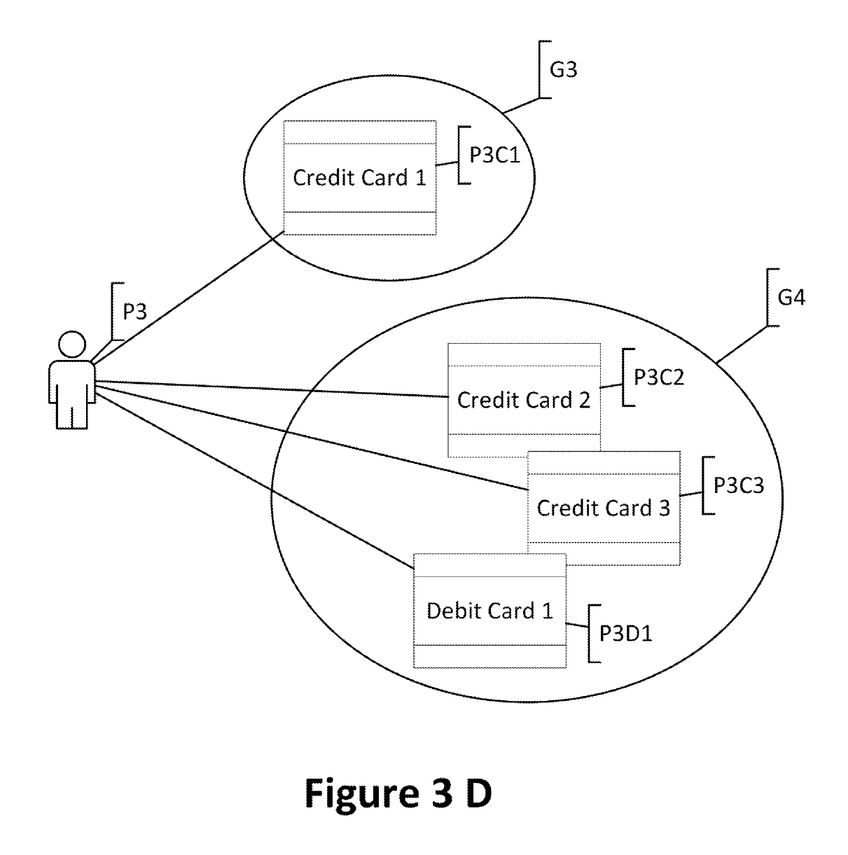

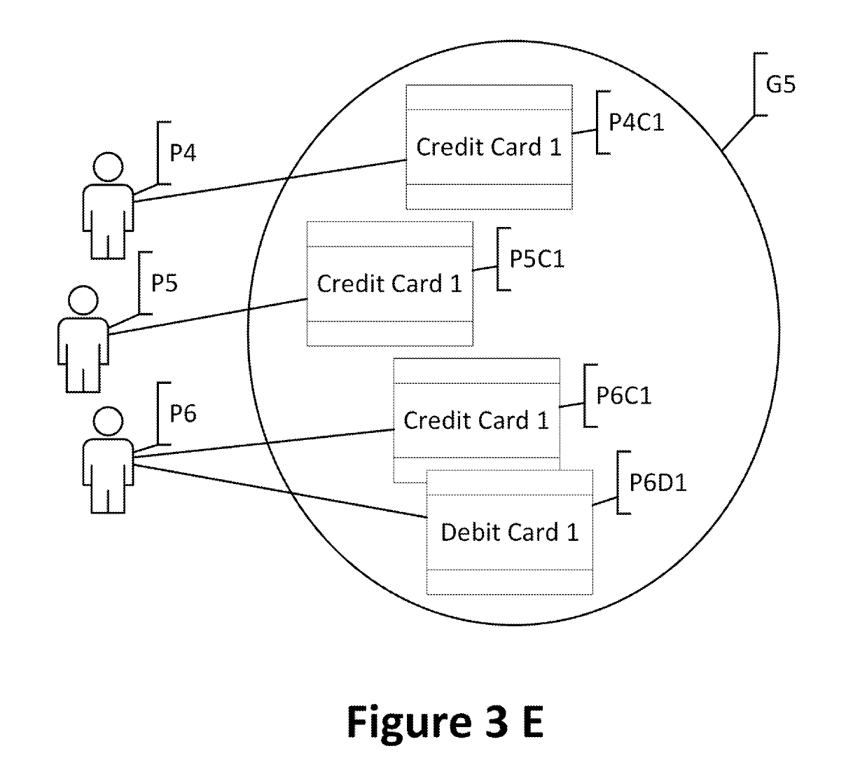

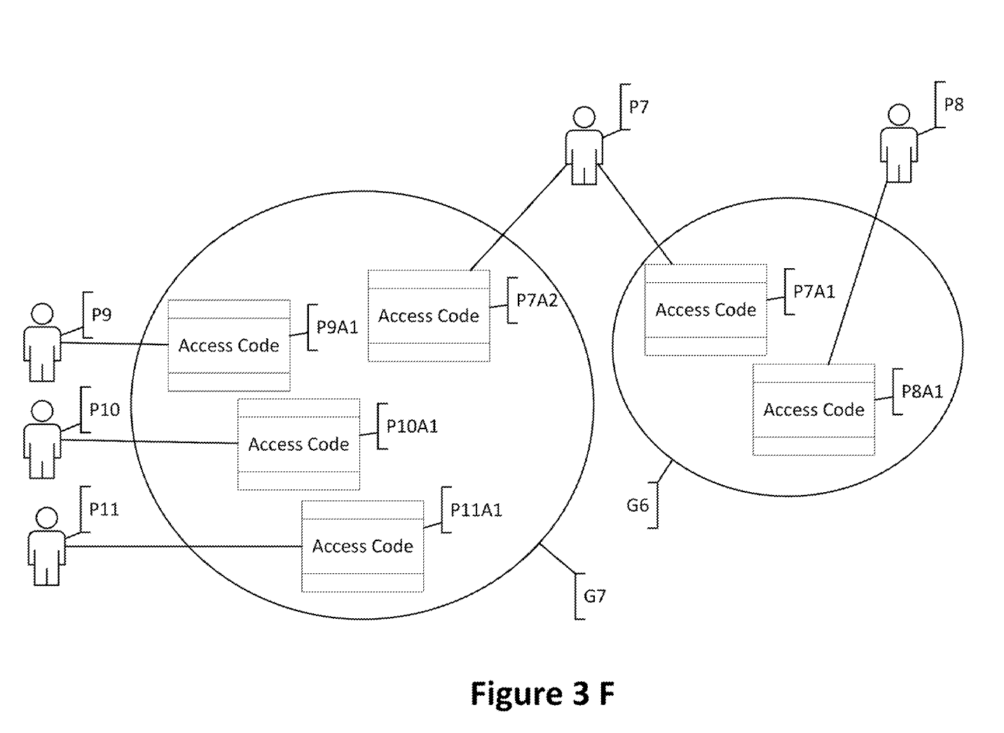

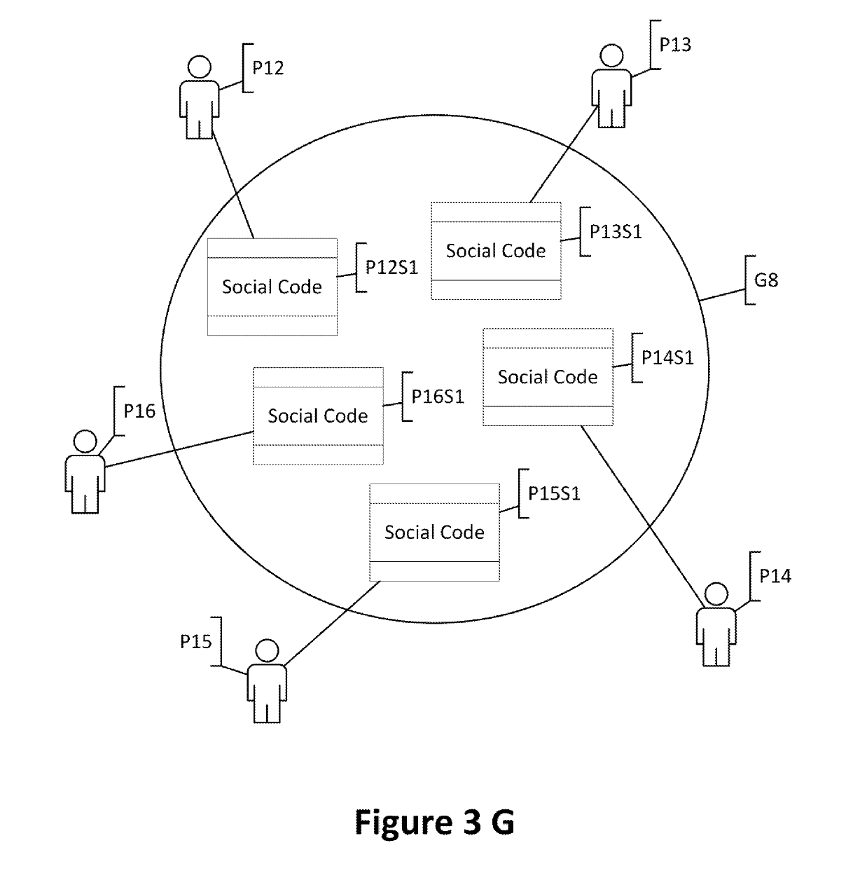

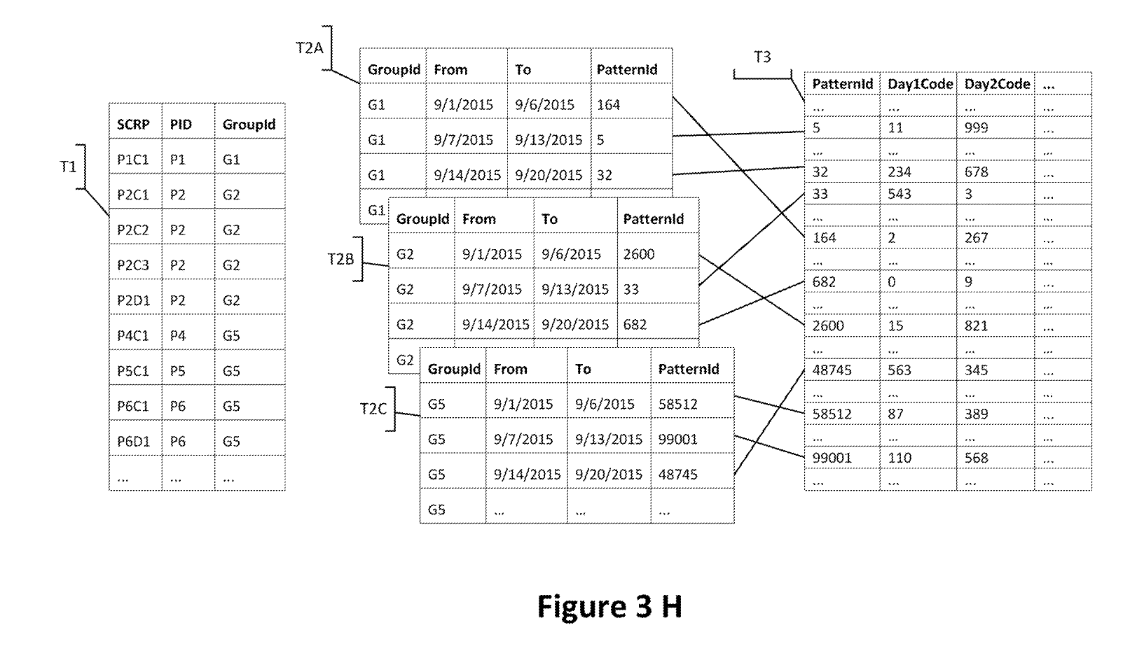

For the purposes of the process described, this matrix of Temporary Known Random Patterns generated as depicted in this flowchart will then be used to assign each enrolled account holder with a Pattern ID as depicted on step 211 in FIG. 3 so that a new random security code can be used for transactions initiated by the account holder 5.

In order for payment processors to be able to support payment transactions according to the present invention, an identical version of the matrix (as may be occasionally updated or otherwise revised) is distributed to each participating payment processor at step 109. Preferably, each participating payment processor's version of the matrix is hashed in a manner unique to that payment processor, before being distributed. The uniquely hashed matrix is then locally loaded by each payment processor on the security code database server 4 associated with that payment processor.

The random number values in the matrix are preferably hashed utilizing a Secure Hash Algorithm (SHA) that is approved as secure and reliable by industry standards and regulations. For instance, SHA-512 can be used in accordance with this aspect of the present invention. Several Secure Hash Algorithms, including SHA-512, are disclosed in, for example, Federal Information Processing Standards Publication 180-4, published in March 2012, the contents of which are incorporated by reference herein to the extent permitted by the relevant patent offices. In order to hash the random number values in the matrix before they are transmitted out to the Payment Processors or Banks, each payment processor is assigned or otherwise associated with, for example, a unique Hash Salt 111 obtained at step 110 (from HSM 2, for example). This Hash Salt 111 is also communicated in a secure and encrypted way to each respective Payment Processor for use in the transaction authorization process. As is known in the art, a “hash salt” is the mathematical basis for a given hashing process. It should be noted that a given hash salt, applied using a given hashing algorithm, with respect to a given string (for example, one of the numerical security codes of the present invention), will always result in the same hashed version of the string.

Using the respective unique hash salts 111 (i.e., a unique hash salt for each respective payment processor), unique hashed copies of the same matrix are created for the different payment processors (step 112), each matrix containing a uniquely hashed representation of the random numbers. Therefore, the actual sets of random numbers generated and assigned to each Pattern ID are only kept in the clear at the central database server 1 in order to communicate them to the registered account holders. Each Payment Processor will only hold “its” distinct hashed representation of these values, different from the hashed representation of any other Payment Processor, on their corresponding instances of security code database 4 (step 113).

FIG. 3 illustrates a process of how an account holder 5 enrolls in the system according to the present invention. An account holder 5 initiates an enrollment request. If an account holder enrollment profile already exists 201, the account holder 5 can proceed to register new/additional accounts to the existing profile at step 212. Otherwise, if a new account holder enrollment is needed, account holder 5 proceeds at step 202 to enter information required to create an enrollment profile. This information may include, for example, full name, a billing address, contact information (such as mobile phone number or email address), and notification preferences. The information is validated at central application server 3 by a sub-process 203 to verify the entered account holder information. This sub-process 203 may include address verification, Identity Verification Services, and other types of Know-Your-Customer verification steps.

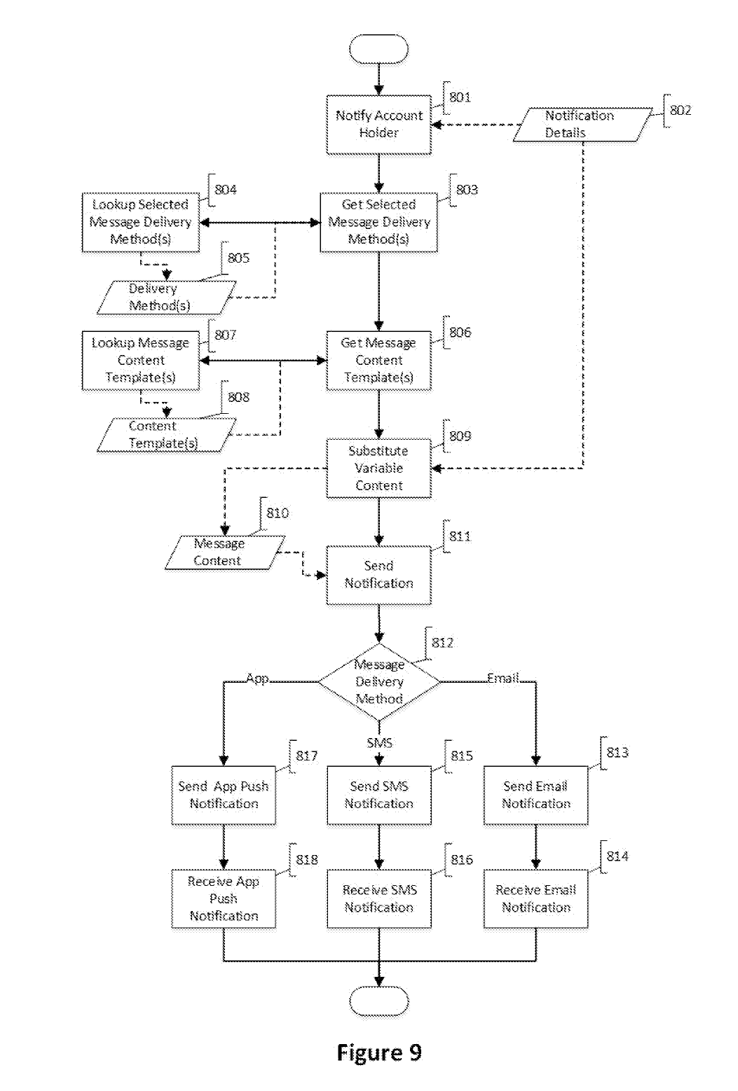

Once the account holder information entered passes the verification step (step 204) a temporary random alphanumeric or numeric code is generated at 205 and sent to the account holder via notification sub-process 800 via the email address or mobile phone number entered, in order to verify that the account holder 5 has either access to the email address, or to the physical device associated with the mobile phone number provided. Upon receipt of the temporary code (which has a limited lifespan) at step 206, the account holder 5 is asked to re-transmit it back into the enrollment application service at step 207, which is then validated by the central application server 3. If the temporary code entered by the account holder matches the one generated at step 205 and it is still valid time wise (step 208), the account information collected is used to create an account holder profile (step 209) and stored at step 210 on central database server 1. When the enrollment profile is created in the central database server 1, a Pattern ID 104 (see, for example, FIG. 2A) is assigned at 211 to the newly created account holder profile, by which the account holder 5 will be identified in the matrix of security codes. This will then drive the security codes that the account holder 5 will be presented with as depicted in FIG. 4. The account holder is then notified via sub-process 800 (see FIG. 9) of the results of the profile creation according to their notification preferences, which could include one or more of an SMS text message to the mobile phone number provided, an Email message to the email address provided, or a mobile application push notification. This account holder enrollment result notification could include information necessary to interact with the service, including but not limited to, a unique account holder profile identifier, and a Code to use when making electronic payment transactions.

Once an account holder profile exists, the account holder 5 can then proceed to associate one or more accounts with their account holder profile (212). The account registration process 212 may include identifying a new account 213 (such as a debit, credit, or checking account) and entering account information (step 214). For a Bank Account this includes the Account Number and the Bank's Routing and Transit Number (RTN). For a Card Account, this may include the full Card number (typically 15-16 digits, sometimes less and sometimes more), expiration date, any verification code printed on a physical Card of any shape or form, or a digital verification code in the case of an EMV (Europay, MasterCard, and Visa), or virtual Card if applicable.

Central application server 3 verifies whether the Account information entered is valid. Using conventionally available resources that map the card's Bank Identification Number (BIN) or account's ABA routing number (RTN) to the corresponding Bank or Payment Processor (cross-referenced to financial institutions and/or Payment Processors that have signed up to support the system according to the present invention), the given account is checked for eligibility at 215 to participate in the system of the present invention.

If the account is eligible (step 215), then the system proceeds to a sub-process 216 to verify that the account entered legitimately belongs to the account holder, otherwise the account holder is notified via notification sub-process 800 that the account cannot be added. The account verification step may include a call to a web service (e.g., operated by a payment processor, or a card issuer, or another third party) that verifies account holder information, or a Zero Dollar Value authorization request which can include Address Verification and CVV verification, or any other service provided by an authorized institution to verify the Account's authenticity. In the case of a Bank Account, the verification process could include a series of small trial deposits, for instance two deposits of random amounts between 1 and 99 cents that the account holder would then have to verify by confirming the amounts received.

After an account is verified at 217 as validly belonging to the account holder 5, the system proceeds to add that account at 218 to the account holder profile, and store it at 219 on central database server 1. The account's payment processor or Bank ID information is then retrieved in step 220 by looking it up at 221 on central database server 1. With that ID information 222 the system then sends the information at 223 to the payment processor's database server 6 by either calling an API provided by the payment processor, or a file transmitted and loaded onto the payment processor's system, or any other means provided by the payment processor to update their system to note the addition of the given new account. The information transmitted to the payment processor includes the account holder's enrollment profile information and particularly the Pattern ID associated with it to allow the Processor to validate the account holder's security code in a current matrix of security codes in future transaction authorization requests.

Finally, the account holder is notified via notification sub-process 800 and receives a confirmation of account registration at 224.

The presently disclosed method and system for generating and managing security codes can be used in domains other than electronic payment security and financial transaction security. For example, a worksite, laboratory, office, etc. may implement the present invention to deliver a security code every day to employees as an additional authentication or access control mechanism. In a different field, the codes according to the present invention could be implemented as an additional proof of identity for account holders to apply for credit, new accounts, or services from a merchant, service provider, or other types of government or private institutions.

An account holder can register to receive a daily security code according to the present invention for use within a single domain or across many (particularly, many unrelated) domains, as described above. For instance, an account holder may register credit cards from two different issuers/processors, as well as relative to the account holder's workplace access control system, and so forth. An account holder with multiple registration profiles as described above may want to choose to group those profiles together in one or more groups, each with a respective security code according to the present invention. That is, the account holder can therefore use a single (or at least, fewer, compared to the total number of domains requiring security codes) security code each day valid for all the different implementations for which the account holder is registered. In an example of such grouping of implementations, a Security Code Registration Profile (SCRP) is a single instance of an individual user and a single financial account, or non-financial account that requires a secure access. Non-financial accounts include, but are not limited to website access, computer sign-on screens, or a physical access control situation. In the present invention, an SCRP is a single account holder's profile in a single processor's database.

To enable easier use while reducing the number of security codes to remember and use, multiple credit cards, debit cards, financial accounts, and secure log-ins can be grouped as desired. Once grouped, all SCRPs in that group will have the same pattern id, and will receive the same security code each day. In this way, for example, an individual could receive the same security code for all of their debit cards and credit cards.

The grouping does not have to be limited to a single individual. A family, for example, could choose to have all of the credit cards and debit cards for the entire family in the same group, and then all family members would have the same security code each day for all of their credit cards and debit cards.

In another example, all of the employees of a business who have corporate credit cards could be grouped and would then receive the same security code each day for each of their respective corporate credit cards. In another example, all members of a military squad/platoon/unit/etc. could receive the same security code each day as a way to confirm membership in their platoon.

Individuals could be members of several groups, as well as have SCRP that are not members of any group. For each group, and non-group SCRP, an individual would receive a unique security code. For example, a person could have all of their credit cards, debit cards, in a “family group”; their single business credit card in a “company group”; and their checking account “ungrouped”. In that case, each day the person would receive three unique security codes according to the present invention.

The grouping criteria may be determined by rules pre-established by the system, or by each account holder, or by a privileged administrator for a group of groups. For example, automatic grouping rules may include that if two account holder profiles share the same email, phone, or other previously verified contact information, the codes produced and delivered each day for those matching profiles will be grouped and synced up to be the same each day.

In another example, a registered account holder is given the ability to initiate an invitation request to be grouped with another account holder's profile in order to receive the same code each day for a particular implementation, upon the authorized account holder or group administrator's authorization.

FIG. 3A illustrates the high-level steps introduced when an account holder's profile is to be grouped together with another account holder or group, either automatically or on demand.

When a group assignment process 231 is initiated, if requested on-demand 232 by an account holder, a request for authorization to join a group 233 is initiated. If the account holder is authorized 234 to join the group requested, the account holder's enrollment profile instance is assigned in step 235 to the group requested, and a notification process 800 is initiated to notify all relevant stakeholders in the group assignment process. If however the account holder is deemed not authorized to the requested group in step 234, no action is taken and the account holder remains in the currently assigned group per step 236. The notifications step 800 is also triggered in this scenario to alert stakeholders of the unauthorized attempt to access the requested group.

On an alternate path where the request to join the group is identified as not on-demand (i.e., it is automatic) in step 232, then a process to find automatic profile grouping rules for the account holder is performed in step 240. If rules are found to match the criteria established in step 241, the account holder's enrollment profile instance is automatically assigned to an existing group in step 242 and notifications are sent accordingly in step 800. Otherwise, no action is taken and the account holder remains in the currently or newly assigned group per step 236, and notifications are initiated in step 800.

Some examples of the groups referenced above are subsequently illustrated in FIGS. 3B through 3G. FIG. 3B for example illustrates a single individual P1 with a single Security Code Registration Profile, in this instance a Credit Card P1C1, which belongs, by itself, to its own group G1. This means that account P1C1 does not share a security code with any other registered account. In other words, that Pattern IDs and their associated security codes are not being intentionally matched up.

It should be noted that each Security Code Registration Profile (SCRP) is assigned a Pattern ID, which at any given period of time is assigned a specific Security Code. Because there are a finite number of Security Codes available, even if that number is very large it is reasonably possible that at any given instant two different Pattern IDs will have the same Security Code assigned to them.

FIG. 3C illustrates a single account holder P2 with three different credit card SCPRs P2C1, P2C2, P2C3, as well as one debit card SCRP P2D1, all of which are grouped together in a single group G2. This means that all four accounts registered under these SCRPs will receive the same security code corresponding to group G2 each day, according to the present invention. A practical example of such scenario is an account holder who wants all the cards in his wallet to receive the same security code each day.

FIG. 3D shows a single account holder P3 which has one credit card SCRP P3C1 by itself in a group G3, as well as two other credit card SCRPs P3C2, P3C3, and one debit card SCRP P3D1, the three of which are grouped together in group G4. This shows an example in which an account holder may choose one or more SCRPs to be grouped in one group, and one or more others to be grouped in a separate group, so that the two groups receive a separate security code each day.

For example an account holder may have all his personal credit and debit cards grouped together to receive a single security code valid for all of them each day, and a separate group for his business credit and debit card accounts which receives a different security code than the one valid for his personal accounts.

FIG. 3E shows an example in which different SCRPs belonging to different individual account holders could also be grouped together to receive the same security code each day. This feature could be used for instance by members of a family, business, organization, or social group who want to receive the same security code each day for a set of accounts under different Security Code Registration Profiles. In this example, credit card SCRPs P4C1 belonging to account holder P4, as well as credit card SCRP P5C1 of account holder P5, and SCRPs P6C1 and P6D1 both belonging to account holder P6, are all registered under a single group G5. Each account holder P4, P5, and P6 therefore receives the same security code each day.

As expressed previously above, security codes can be used in domains or applications other than electronic payment security and financial transaction security. FIG. 3F illustrates multiple individual account holders P7-P11 with access code SCRPs, which could be for example a security code used to physically access an office building, or virtually access a website or network on a secured public or private network. In this illustration, all access code SCRP's P7A2, P9A1, P10A1, and P11A1 belonging to individual account holders P7, P9, P10, and P11 respectively, are grouped together in a single group G7 in order to receive the same security code each day. At the same time, individual account holder P7 also holds a separate SCRP P7A1 which belongs to a separate group G6, shared with another SCRP P8A1 which belongs to a different individual account holder P8. SCRPs P7A1 and P8A1 also receive the same security code each day for as long as they are both associated with the same group G6. In this example, a single account holder P7 holds multiple SCRPs that are registered and which are in different groups G6 and G7 with different individual account holders. A practical application of such example could be an individual who plays two different roles, for instance “restricted-user” and “administrator-user” on different networks, and needs a different security code for each role, shared with other individuals in each group.

Another domain illustrated here is referenced to as social code, which could be a security code which is used by individual account holders to get access, privileges, or simply be recognized or identified as belonging to a social group, for instance a secret social club. FIG. 3G illustrates multiple individual account holders P12, P13, P14, P15, and P16, each with respective social code SCRPs P12S1, P13S1, P14S1, P15S1, P16S1, all in the same group G8, guaranteeing that they all receive the same security code each day.

FIG. 3H shows an example of how the SCRPs and the groups to which they are assigned can be represented in a tabular form and stored in a database in order to implement the present invention. Table T1 holds each instance of SCRP, the PID of the account to which (the entity) it belongs, and the assigned group GroupId (e.g., G1, G2, G3, etc.). Tables T2A, T2B, and T2C are each segments of a table that holds which security code pattern PatternId is assigned to each group GroupId in a given date period (i.e., validity period). The date period is represented by a “From date” and a “To date” designating the beginning and end dates of each period for which the assigned PatternId is valid. Each PatternId is then represented in table T3 which assigns a different security code for each day Day1Code, Day2Code, and so forth. That way, each day it can be determined which security code is valid for a particular SCRP by traversing these tables looking up which group GroupId the SCRP is assigned to; then looking up which PatternId is valid for that GroupId during that given date/time period; and then looking up which security code is assigned to that PatternId for that particular date/time period (Day in this example). A GroupId and date combination always renders the same security code (two codes during the short duration of a date/time period change), independent of how the PatternId assignment is rotated for each GroupId. Hence two SCRPs sharing the same GroupId assignment are guaranteed to also share the same security code each day.

FIG. 4 describes the steps that take place during the process of providing registered account holders with their corresponding active security code(s) on a regular basis.

To receive the currently active security code associated with an account holder's profile, the account holder 5 can either request the security code or receive it automatically via an automatic push driven from central application server 3.

If the code is requested by the account holder 5, a request 301 is sent from account holder 5, for example, via a device-installed application or by calling a web application that in turn communicates with an API at central application server 3 to retrieve at least a current security code for the account holder (such as an API call from a payment processor's or account holder's Online Banking website page), or by sending a mobile-originated SMS text message to a system-provided SMS Short Code that directs text messages to the central application server 3, and which then initiates an SMS response (including the current security code) back to the account holder 5.

The request from the account holder 5 should contain the Profile ID 302 that identifies the account holder, and a source identifier identifying the device or application from which the request originates. The Profile ID should uniquely identify the enrollment profile associated with the account holder 5. The device's source identifier could be the mobile phone number used to send the request, or a mobile application identifier, or any other ID that is tied to the device used to perform (i.e., send) the request. Preferably, the request contains both the source identifier (source ID) and a profile ID in order to validate the authenticity of the request.

To find the account holder profile (step 303), the central application server 3 calls a process in central database server 1 to lookup (step 304) the account holder Profile. In order to maximize authentication security, the process first verifies the source ID as being an authorized device/input source known to be associated with the registered user or account holder. If an account holder profile is found at 305 using the Source ID received, and the Profile ID indicated by the account holder in the request is valid (step 306) for the identified account holder Profile, then the central application server 3 proceeds to fulfil the security code request (step 307). Otherwise, if the Profile ID does not match the identified account holder Profile, the notification sub-process 800 is used to notify the account holder that an invalid security code request was received. The sub-process 800 can use one or more notification preferences specified in the account holder profile, such as an SMS message, or an email message.

The account holder 5 can alternatively reply to a notification received from the system, or initiate a request (for example, in case of suspected fraudulent activity) to renew or replace the current security code. In this case, central database server 1 assigns a different Pattern ID 104 to the corresponding account holder's enrollment profile, and pushes this update to all participating payment processors. The account holder is then notified (step 800) of the new current security code associated with the new pattern ID (and, in effect, the new underlying matrix).

For an automated periodic “push” of a current security code, a request 312 is automatically sent to look-up the account holders 5 in the central database server 1 eligible to be provided with an updated security code notification (step 313). The frequency of these updates can be selected by account holders, as can the time of day the updates are sent. Once the group of account holders needing automatic updates is established, a sub-process (labeled “For Each account holder” in FIG. 4) is run to notify each of those account holders of their current security code.

In order to send a notification or an alert to an account holder (in either case above), the central application server 3 initiates a request 307 to lookup a given account holder's security Code (step 308). From the account holder's enrollment Profile ID, the corresponding Pattern ID is retrieved, and the security code that corresponds to that pattern ID for the current validity time period (the current date, for example) is pulled from the Temporary Known Random Pattern matrix or table. The account holder 5 is then notified (800) of the current security code.

This notification of the current security code could be simply a return on a Web or Desktop or Mobile application request, or a Web Browser Plugin application installed on the account holder's device. The security code could also be delivered based on the account holder's previously established notification preferences, for example, via an SMS text message to the mobile phone number registered and validated for the account holder, or an Email message, or a mobile application push notification.

In a variant of the present invention, the process of providing a user with a new security code could additionally incorporate periodically changing the pattern ID (i.e., not just updating the security code within given set of security codes) so that the user is then in effect associated with a completely new set of security codes. For example, on a periodic basis (for example, every 7 days), a sub-process (not illustrated here) can be executed that would regularly reassign every user to a new pattern ID. For example, if the pattern IDs are numeric, then an RNG (possibly but not necessarily the same used in HSM 2) could be used to generate a random new pattern ID within the available range of pattern IDs to which the user would be reassigned.

Periodically reassigning the pattern IDs desirably further increases the randomness of the association of any given security code with any given user, and therefore helps the system resist hacking, pattern deduction, and other efforts to access a user's security codes and/or predict future security codes.

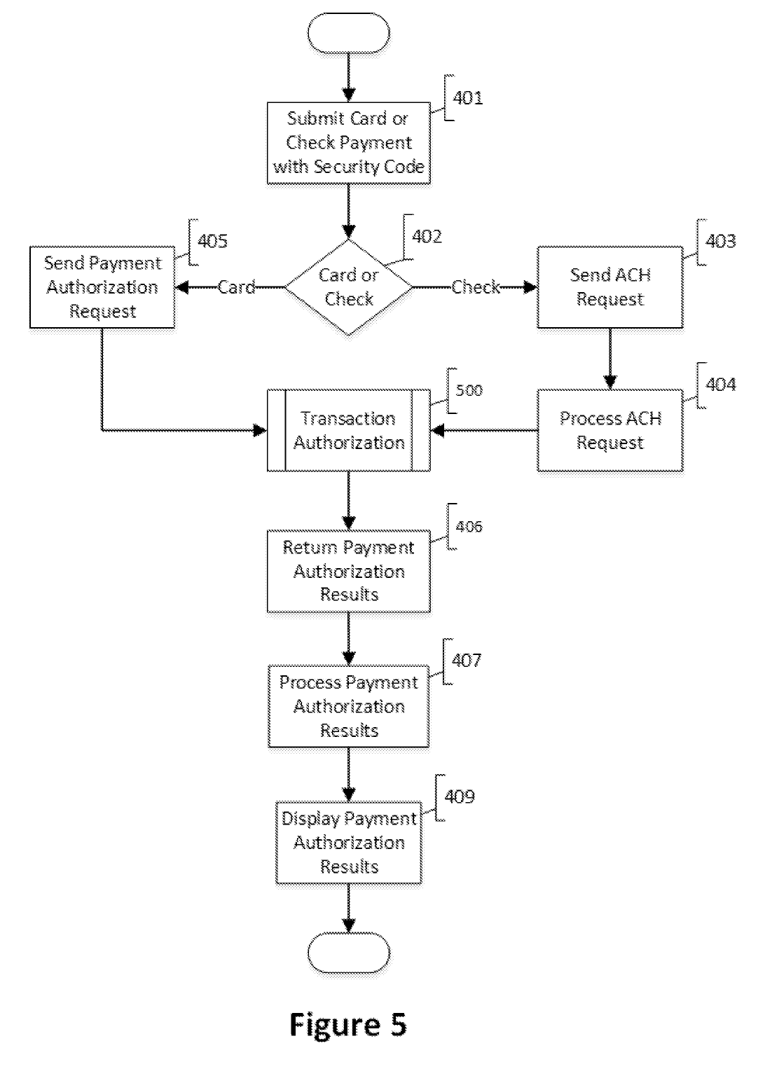

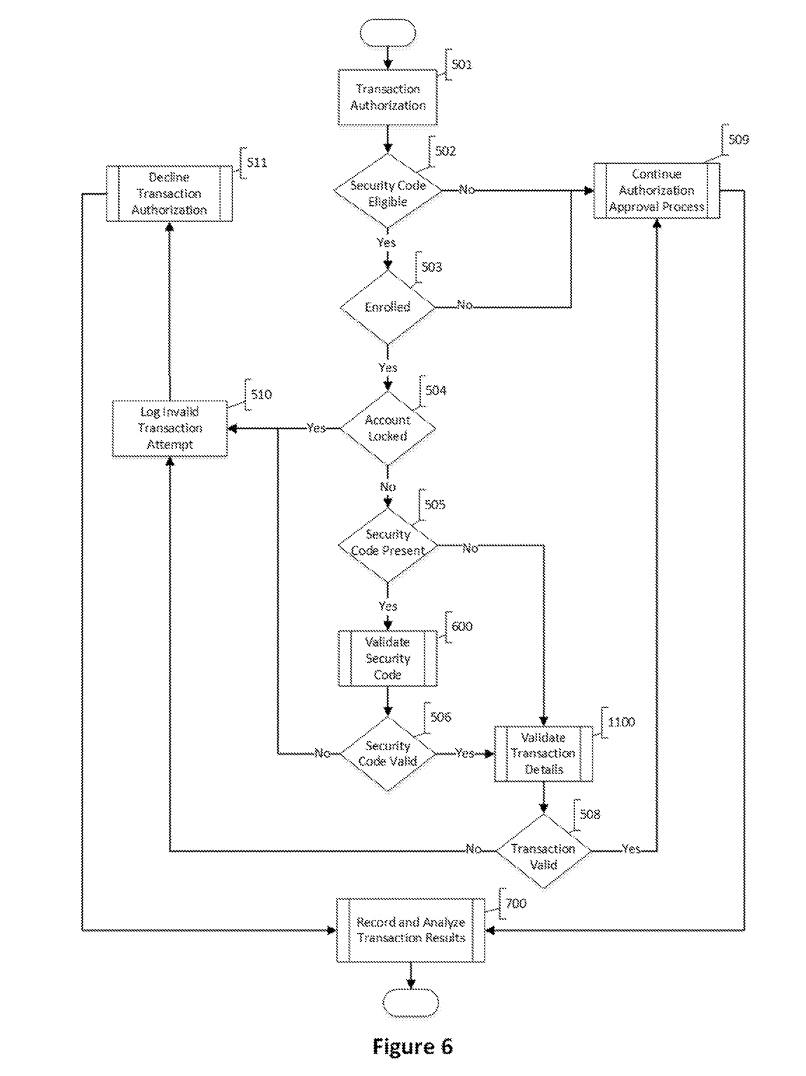

FIG. 5 illustrates at a high level an electronic payment authorization request made by the account holder 5 to a Merchant or Payee payment interfaces, for example, in making a purchase. The main focus here is on the call to transaction authorization sub-process 500 which is later described relative to FIG. 6 in greater detail.

At the time of a purchase or the initiation of a like electronic payment transaction request, the account holder 5 submits the information necessary to initiate a payment authorization request (step 401) to complete a transaction with the Merchant or Payee 7.

Assuming that the transaction relates to an account that has been previously associated with the profile of the account holder 5, the account holder 5 generally includes the currently valid security code as part of the transaction request. For example, the security code could be submitted in the same way as, but in place of, the conventional CVV2 code of a payment Card, or in place of other Card information like the CVV, or concatenated with the Card number, or embodied by an electronic token or proxy number, or in a separate field dedicated specifically to receive a security code according to the present invention.

For check payments, the security code of the present invention could be specified in a Check's memo field, for example, with a field indicator in the Check's memo field. For example, a 4 digit security code according to the present invention could be prefixed with a word or symbol. It could also be delimited on both sides by a predetermined symbol or character, for instance “+” as in “+4567+”.

Alternatively, the security code could be concatenated with the printed check number on the check, to create effectively an extended check number according to a pre-defined and commonly accepted and expected format. For example, check number 101, used with a security of, for example, 456, could actually be printed with “101456” in the usual check number field. The check would then be processed in the usual manner in an ACH file by the receiving bank with the extended check number “101456.”

In other examples, the security code could be given separately by the account holder manually in writing in an input field, or verbally to a live person or via a voice-recognition system. The merchant then includes the information in the ACH request file (for example, within the addenda or entry detail fields).

The Merchant or Payee 7 has a conventional payment Interface that receives the information submitted by the account holder 5. Depending on whether the account holder 5 uses a Card or Check 402, and if the merchant is connected online, the system either immediately sends an electronic payment authorization request 405 over to the relevant Payment Processor (see 6, in FIG. 1), or schedules, forms, and later sends an ACH transfer request 403 to the relevant Payment Processor via the channels previously established between the Merchant or Payee 7 and the corresponding payment processor, receiving bank, or other financial institution to process the ACH requests. This could include a payment gateway service provider, a payment processing network, a Federal Reserve Bank or the Electronic Payments Network, or any other service or server intermediary between the Merchant or Payee 7 and the Processor or Receiving Bank.

The Payment Processor then initiates the transaction authorization sub-process 500, described in detail below relative to FIG. 6, either by receiving a Card payment request or as part of the processing of an ACH transaction request 404. This sub-process 500 approves or declines the transaction authorization request, and the result 406 is sent back at step 407 to the merchant or payee 7 in a manner appropriate for the needs of the merchant or payee 7. In turn, the merchant or payee 7 notifies the account holder 5 of the authorization result at account holder interface 409.

FIG. 6 illustrates the sub-process 500 of transaction authorization. When a Card or Check Payment process 400 is initiated in accordance with FIG. 5, the Payment Processor or Receiving Bank decides at 502 whether the transaction type and account being used is eligible for processing according to the present invention. The payment processor does this by either querying a database table or a configuration file (for example, located on one of the servers associated with the payment processor, such as the security code database server 4 or the database server 6) that contains the necessary information to determine if the transaction is eligible for processing according to the present invention, or by issuing a call to an API hosted either within the payment processor's network or remotely (relatively) at the central system illustrated in FIG. 1. Eligibility could also be determined by inspecting certain indicators contained on the transaction authorization request payload, for instance in one of the ISO 8583 fields, or the NACHA ACH file received.

If the transaction does not qualify for processing according to the present invention at 502, then the payment processor continues a normal (i.e., conventional, not using the security code of the present invention) authorization approval process at 509. Otherwise, the processor's database server 6 issues a call to an application or process implemented and installed at the processor's security code database server 4 (which could be local to the processor's network or at a remote location) to initiate the verification process of the transaction. The processor's database server 6 interfaces with the processor's security code database 4, for example, by issuing a remote stored procedure call, or an extended stored procedure, or a SQLCLR that interfaces with an assembly installed on the processor's database server 6 that has access to the processor's security code database 4. Alternatively, the processor's database server 6 communicates with a local or remote service or API that in turn has access to the processor's security code database 4.

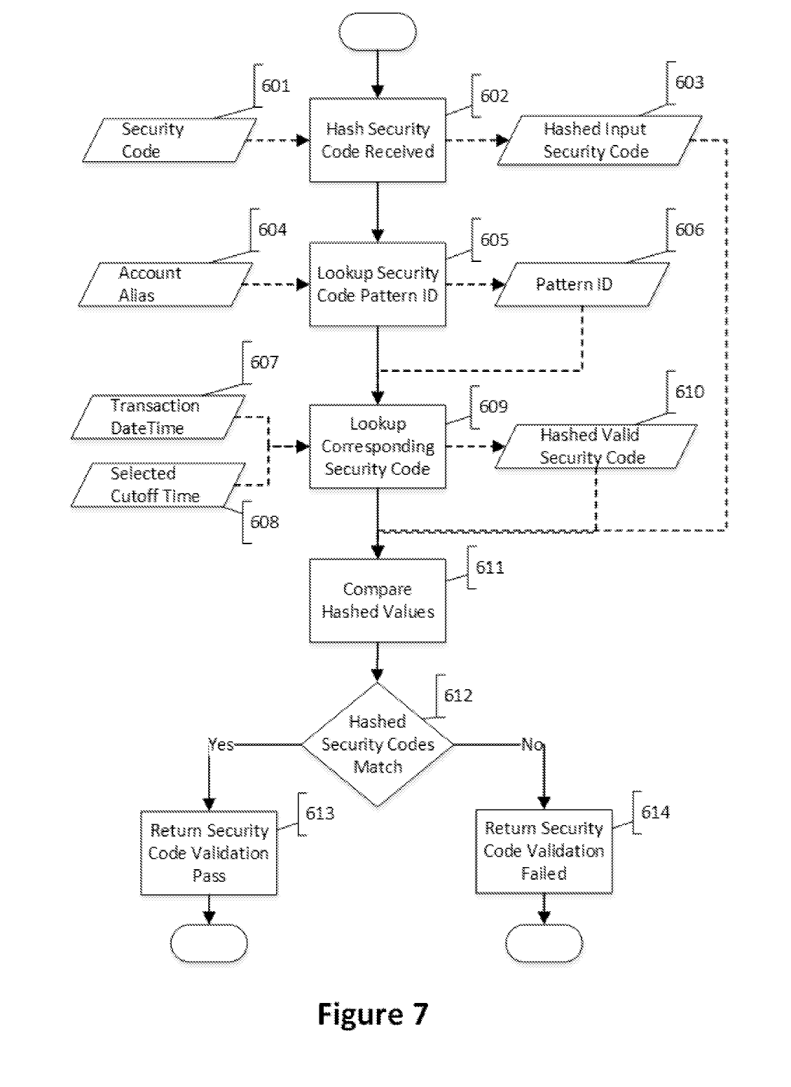

The information received from the processor's database server 6 as part of the authorization request is inspected to determine if the account in question is associated with an active account holder enrollment profile stored on the processor's security code database 4. The transaction data received from processor's database server 6 is used to lookup the Account Holder's enrollment Profile ID and the corresponding Pattern ID 104 to retrieve the valid security code associated with the Account Holder and the Card or Account used. In one example according to the implementation described here, this transaction data may contain an account alias 604 (see FIG. 7) instead of the actual Card Number or Bank Account Number used by the Account Holder 5 (to further limit circulation of sensitive financial information). An account alias in this sense is a representation of the card number or bank account number used by the payment processor, principally on an internal basis, in order to minimize circulation of card or bank account numbers. It is not necessarily known to the account holder. Usually a token or a proxy number is used by the payment processor, but according to the present invention, the Card Number or Bank Account Number itself could be used (though not preferably) or the Profile ID or Pattern ID itself.

Once the account being used in the transaction authorization request is confirmed as being enrolled (503), then the payment processor's security code database server 4 also determines if that account is locked (504) and therefore is ineligible for transaction authorization requests. An account may be locked upon request by the account holder, or may be automatically locked, permanently or temporarily, based on signs of fraudulent activity detected by the system. This detection may be performed internal analytics and algorithms, or a third-party fraud or risk management rules system, or a third-party risk management service such as the commercially available FICO® Falcon Platform. If the account is flagged as being locked in the Processor's security code database 4, then an invalid transaction attempt will be logged 510 for reporting and record keeping. The account holder 5 will also be notified, for example in order to try to correct the blocking issue if needed.

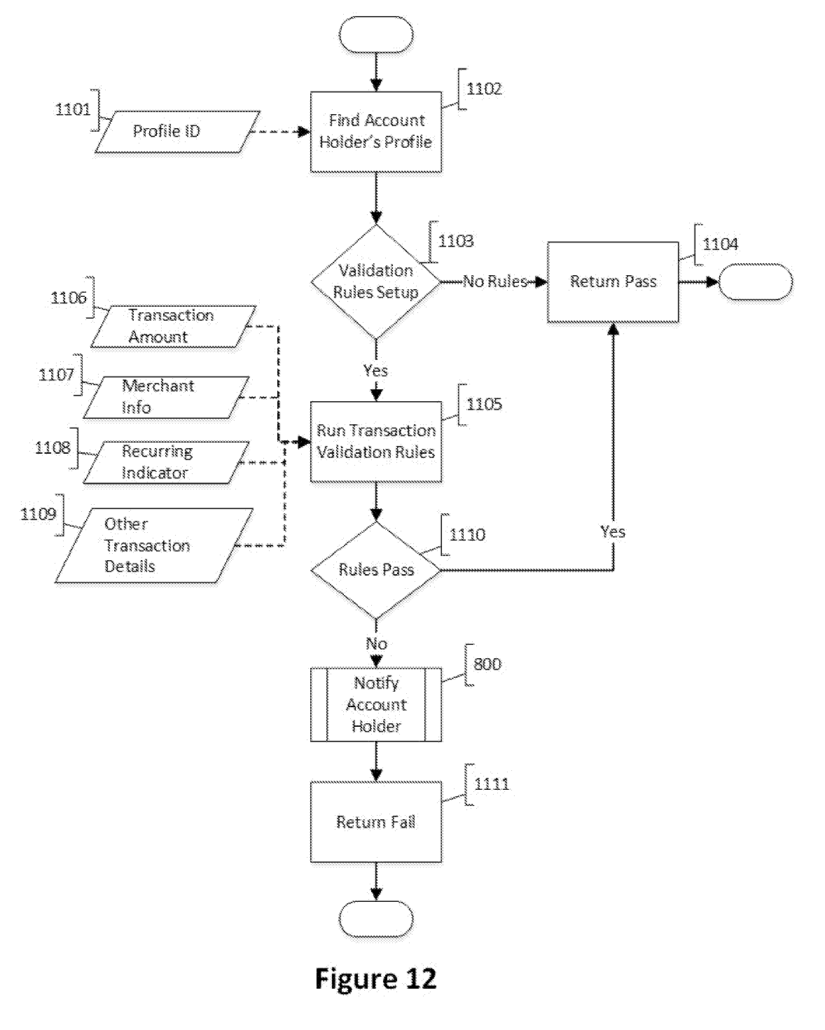

If the account is not flagged as being locked at 504, and a security code has been properly included in the transaction request 501 (as determined at 505), then the payment processor's security code database server 4 proceeds to validate the received security code at sub-process 600 (see the discussion of FIG. 7 below). If the sub-process 600 returns an indication at 506 that the security code is valid, then the sub-process 1100 to validate transaction details is followed (see FIG. 12).

Attention here is drawn to the “security code present?” decision at 505. It will be noted that even if the security code is not present (i.e., submitted as part of the transaction authorization request) at step 505, the process still branches directly sub-process 1100 to validate details of the transaction based on other factors, and eventually to an authorization process not including treatment of the security code of the present invention (at 509). In this manner, even if the security code according to the present invention is not being checked in a particular transaction, other security functions as disclosed herein can still be used.

If the Validate Transaction Details sub-process 1100 determines that the payment transaction request is valid 508, the Processor's security code database server 4 returns successfully back to Processor's database server 6, which then continues the normal course of transaction authorization request approval at 509.

The validation process according to the present invention may only be a part of an electronic payment transaction authorization process, such that success of the validation process according to the present invention may not necessarily result in final transaction authorization by the payment processor.

If, however, either the security code validation fails at 506 or the transaction is considered invalid at 508 according to the Validate Transaction Details sub-process 1100, the invalid transaction attempt is logged at 509 for reporting and record keeping, and the account holder is notified so that corrective action can be taken if appropriate. The notification sent to the account holder's verified device(s) could include the valid security code in case the transaction was legitimately attempted by the account holder, so that it can be attempted again with the correct security code. Notifying the account holder of the invalid attempt also gives the account holder 5 an opportunity to take action to prevent fraudulent use of the account in question, including the possibility of quickly and easily locking any further transaction attempts on that account by, for instance, simply responding back to the notification received with a lock instruction 900. This notification exchange could take place via SMS text message on the validated registered mobile phone number on the account holder's profile, or via an application installed on a device owned by the account holder and properly registered and previously validated.

After the payment processor is advised to either continue the approval process at 509 or decline the transaction authorization request at 511, the processor database server 6 may send back the final transaction authorization results for the system to record and further analyze at sub-process 700.

FIG. 7 illustrates a sub-process 600 by which a security code is validated according to the present invention, as initiated during the transaction authorization sub-process 500 in FIG. 6. Sub-process 600 determines whether the security code submitted by the account holder 5 is valid or invalid.

The processor's security code database server 4 receives a request to validate a received security code at 601, submitted by account holder 5 as part of the transaction authorization request 500. The security code 601 is then hashed at 602 using an industry-accepted Secure Hash Algorithm (SHA), such as SHA-512 to obtain a hashed received security code at 603. More particularly, the received security code 601 is hashed using the same payment processor-specific hash salt 111 that matches the hash salt used to hash the security codes in the matrix when the matrix was originally generated, so the hash salt 111 as kept at the payment processor is used to mirror the hash algorithm by which the security codes in the matrix were hashed when the matrix was generated.

Using the account alias 604 that represents the payment account associated with the transaction being validated, security code database server 4 looks up the corresponding pattern ID at step 605. The pattern ID 606 is then used to search at step 609 on the locally stored version of the hashed matrix stored in Processor's security code database server 4 to look up the hashed value that corresponds to the found Pattern ID 606. The correct security code value in the group of security codes corresponding to pattern ID 606 is determined by utilizing the date and time 607 of the payment transaction, along with the stored cut-off time 608 selected by the account holder, which determines when a respective security code should be renewed (i.e., when the validity of the given security code expires in favor of a subsequent one). The outcome of this lookup operation 609 obtains the hashed reference version 610 of the current security code associated with the account alias 604 that is received. This hashed value is then compared at step 611 in a known manner to the hashed submitted version 603 of the security code.

It should be noted that the authentication comparison between a submitted security code and the stored security code (in the matrix) is done while both codes are hashed. That is, the security codes in the matrix, as kept by a respective payment processor, is always kept in hashed (i.e., obfuscated) form. Moreover, the hashing is “one way”—it cannot be reversed so as to obtain the underlying information in clear form. Accordingly, the security codes are further protected even if the processor's security code database were hacked or otherwise infiltrated, because only a hashed version of the matrix of security codes is located locally to the respective payment processors. Hashing in this fashion helps address the potential problem of dishonest payment processor employees or other “in house” individuals who might otherwise have access to customer security codes.

To authorize ACH or check transactions, only the date (for example, of a check), and not the time, might be specified in an authorization request (taking into account factors such as mail delays or delays in sequential processing). In that case, the submitted security code will be validated against every security code on the matrix that was valid during that day, regardless of the cutoff time. Because actual transaction approval might take place after the preparation and submission of a check, it may be necessary to look up security codes for dates up to 1, 7, 30, or perhaps 90 days prior to the processing's current date.

If the received hashed value 603 and the hashed value 610 from the local version of the payment processor-specific matrix match (step 612), then the process indicates that the security code submitted is valid (613). Otherwise, the system indicates that the code is invalid at 614.

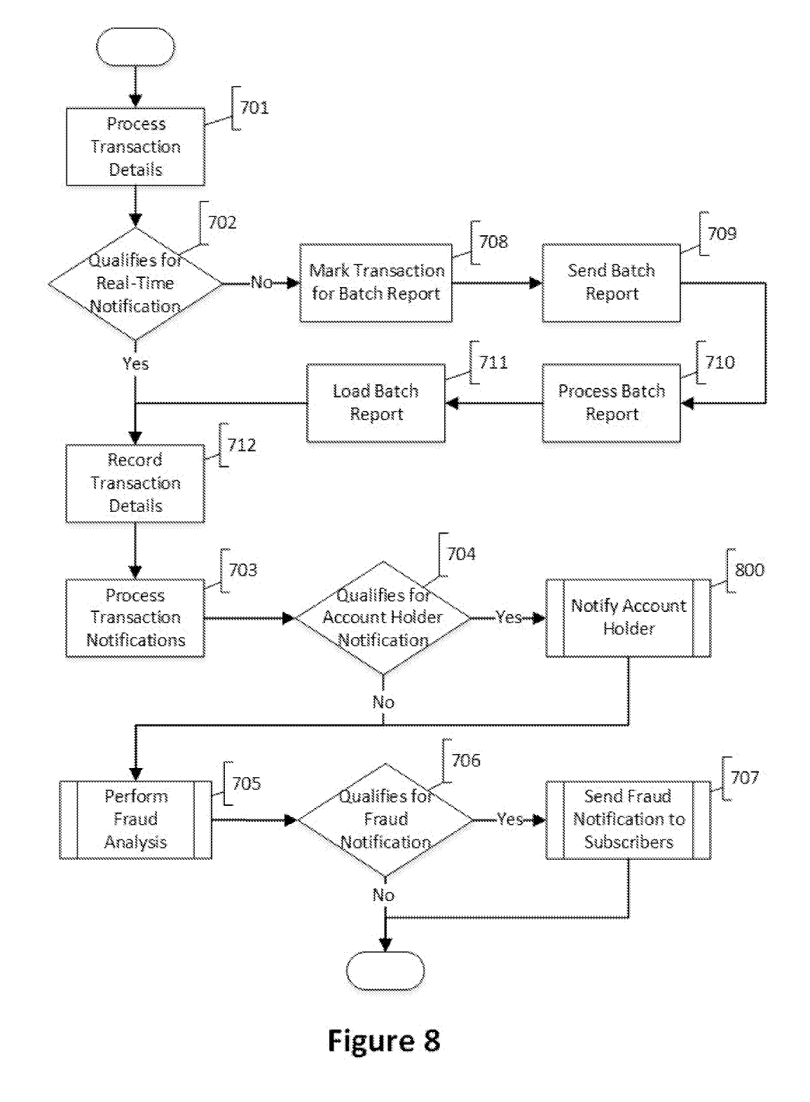

FIG. 8 illustrates the steps of sub-process 700 mentioned in FIG. 6 (recording and analyzing transaction results). This data could, for example, be received simultaneously or near-simultaneously with the transaction request being received and processed at the payment processor's side. Otherwise, the information could be amassed in a periodically-generated report, for instance at the end of each day.

After the Transaction Authorization sub-process 500 completes, a request may be made by the processor's security code database server 4 at 701 to record the transaction details.

At step 702, a determination at the processor's security code database server 4 is made whether the transaction requires or otherwise qualifies for real-time or instant notifications. An example notification would be where an invalid security code was submitted in a transaction otherwise eligible for processing according to the present invention, such that notice to the account holder 5 is required. As a result, a message is posted to central application server 3 by calling the APIs exposed by that server.

When the central application server 3 receives the transaction notification at 703, a determination is made at step 704 whether a notification must be sent to account holder 5. If a notification is required, then the sub-process 800 to notify the account holder is run. (See FIG. 9 below.) A transaction fraud analysis 705 can also be optionally undertaken, using conventional algorithms and other standard analytics. The fraud analysis might consist of an internal set of rules designed to indicate fraud if a certain number or set of conditions are met, or the analysis may be passed to an external third-party fraud or risk management service (not shown here). Optionally, action may be taken to secure the payment method in question, including automatically locking an underlying account, or invalidating a relevant current security code.

Similar to step 704, step 706 considers whether the account holder must be notified about fraud analysis results, and if so, a fraud notification sub-process 707 is followed. Sub-process 707 is not explained in detail here, but in general is similar to notification sub-process 800 (described below) but with specific message payloads.

If the transaction is not marked for immediate or real-time notifications at 702, the transaction is marked or scheduled at 708 to be included in a report that will be sent later at 709 to central application server 3 in a batch process, or the like. This typically represents a batch file with deltas of the new transaction details received since the last batch file was produced. Central application server 3 then processes the batch files received from the processor's security code database 4, and sends them for storage at step 711 on the central database 1. The transactions details received are recorded at step 712 for future review, record-keeping, and analysis, for example, for business intelligence processes, reporting, or billing.

FIG. 9 illustrates steps of the sub-process 800 for sending notifications to the account holder 5. Sub-process 800 is mentioned herein, for example, with reference to FIGS. 3, 4, and 8, amongst others.

When a notification is to be pushed out to an account holder 5, a request is sent at 801 to the central application server 3 with the message payload (namely, specific details or information 802 requiring a notification). For example, when a security code is to be pushed in a notification to the account holder 5, the request 801 contains the security code, information identifying the account holder 5, and possibly information or an indication of the kind of notification to be sent.

The central application server 3 communicates at 803 with the central database 1 in order to lookup (at 804) the account holder's notification delivery preferences. The list of selected preferred notification delivery methods 805 could include, for example, one or more of email (or a specific notifications repository), SMS, push notification via app, pager message, etc.

Optionally, a notification template can be requested by central application server 3 at 806 in order to be able to format the notification in a desired manner. If applicable, template information can be looked up for an account holder 5 on the central database 1 at 807 and 808, possibly based on previously specified account holder preferences.

A notification template in this sense, for example, to transmit a current security code, could be could be “Dear {first-name}, your Security Code for today is {Security-code}.” The variable content in the notification (such as the account holder's first name, as indicated) can be pulled from above-discussed notification details 802, for example, and are substituted into the template as necessary at step 809. Substitution step 809 creates actual message content 810, such as “Dear Maddy, your Security Code for today is 364,” which is sent at step 811 to the account holder 5 via the desired communication method(s) (email 813, SMS 815, or app push notification 817), for example. Notifications, including the template therefor, may be in one of several languages, and the use of other character sets (other than English, for example) is contemplated.

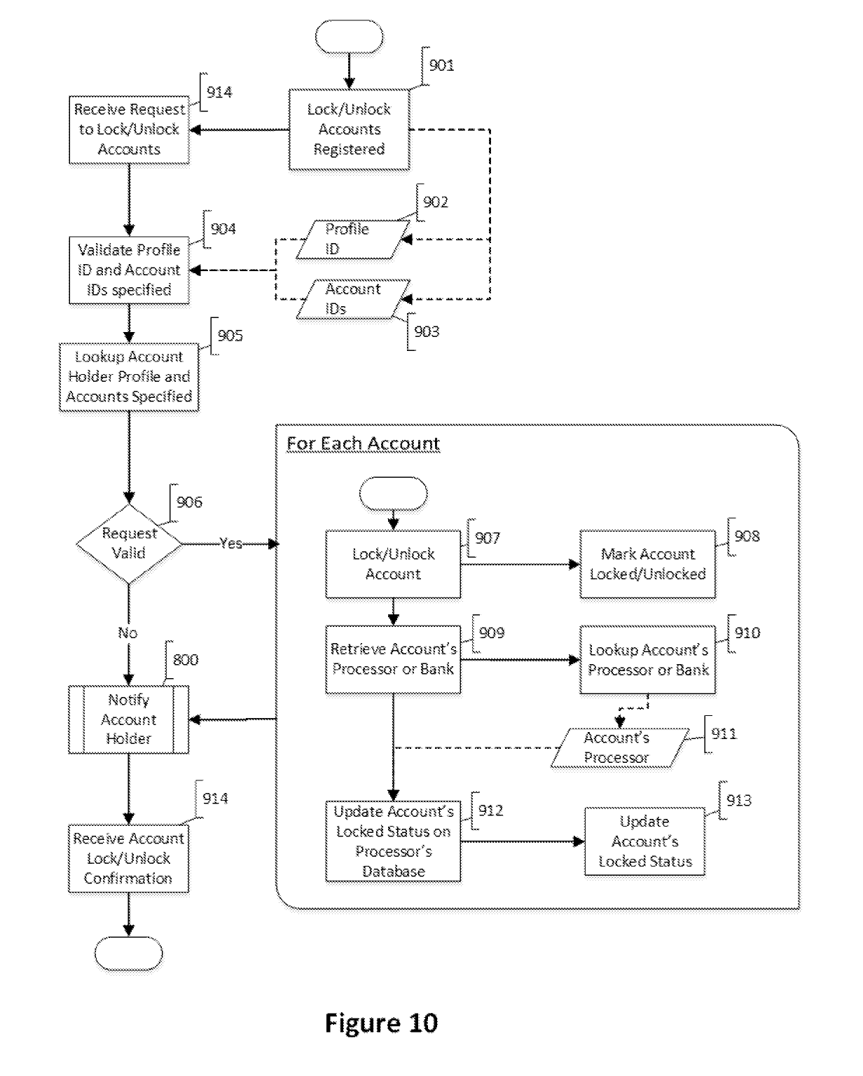

FIG. 10 illustrates a sub-process 900 for selectively locking or unlocking registered payment accounts according to the present invention. The mention of “locked” or “unlocked” in this context is meant to signify controlling an account's current ability (or inability) to be used according to the present invention.

Sub-process 900 allows the account holder 5 to manage multiple accounts issued by multiple institutions and handled by multiple payment processors or receiving banks by interfacing with a single application or service. In one example, an account holder may want to lock one or more of his accounts if there is suspected fraudulent use of one or more of the accounts, or if an associated payment card or check book has been misplaced, or even in the context of parental control of a minor's access to the account(s).

When an account holder 5 decides at 901 to lock (or unlock) one or more of his registered accounts, the account holder 5 sends a request consisting of, for example, his profile ID 902 associated with his enrollment profile, an identification of the account(s) in question (903), and optionally an ID of the device on which the request is initiated (for example, the mobile phone number of a smart phone used by the account holder 5). The request is sent to the central application server 3 and validated at 904. Once the request is validated, the account holder profile is looked up on the central database 1 (step 905).

An account identification (“account ID”) in accordance with the present invention is generally a shorthand and easy to remember representation corresponding to each relevant account of the account holder, and is used to help the account holder to distinguish between his various accounts in his profile in making transactions according to the present invention. An account ID may be a number or alphanumeric word or phrase given by the account holder 5. For example, it could be a sequential number, or a letter, or a combination of letters and numbers to, for instance, identify “Visa Card 4572” or “BofA Bank Account 1721” in the account holder's profile. This Account ID could also be for instance a portion of the card number or bank account number. The Account ID could also be a keyword or number, for instance “ALL,” as a shortcut indicator that all Accounts under the account holder's profile are to be locked/unlocked.

Once the account holder profile is located and indicated accounts are validated (at 906), there is an iterative process (the group of steps indicated in FIG. 10 by “for each account”) to change/update the locked/unlocked status of each account in question.

For each account that is being locked/unlocked, the central application server 3 starts a process at 907 to change the status of the account in the central database 1 to locked or unlocked (908) as requested by the account holder 5. Then the central application server 3 calls up the payment processor or other relevant financial institution at 909, corresponding to a lookup 910 at the central database 1. Once the relevant payment processor 911 is located, the central application server 3 sends an update request to have the processor's security code database server 4 update the status of the account, which is carried out at 913.

Using the account holder notification sub-process 800, the account holder 5 is notified of the result of the lock/unlock operation that was requested, and the account holder 5 receives a confirmation 914.

Requests to lock account(s) could be made subject to certain conditionals, such as a one-time lock during a fixed time period, locked periodically at set time periods, or locked certain during times of day. For example, account holder 5 may request an Account to be locked, preventing any associated transaction from being approved, during the hours of 7:00 pm to 9:00 pm on weekdays, and/or during the week of Mar. 29, 2016 to Apr. 5, 2016. In some cases, only day-wise time periods might be possible to specify (instead of time-wise), such as in the case of a bank check made out on a certain day.

The conditionals could also be applied to, for example, certain merchants, merchant types (no movie theaters, for example), or geographic regions.

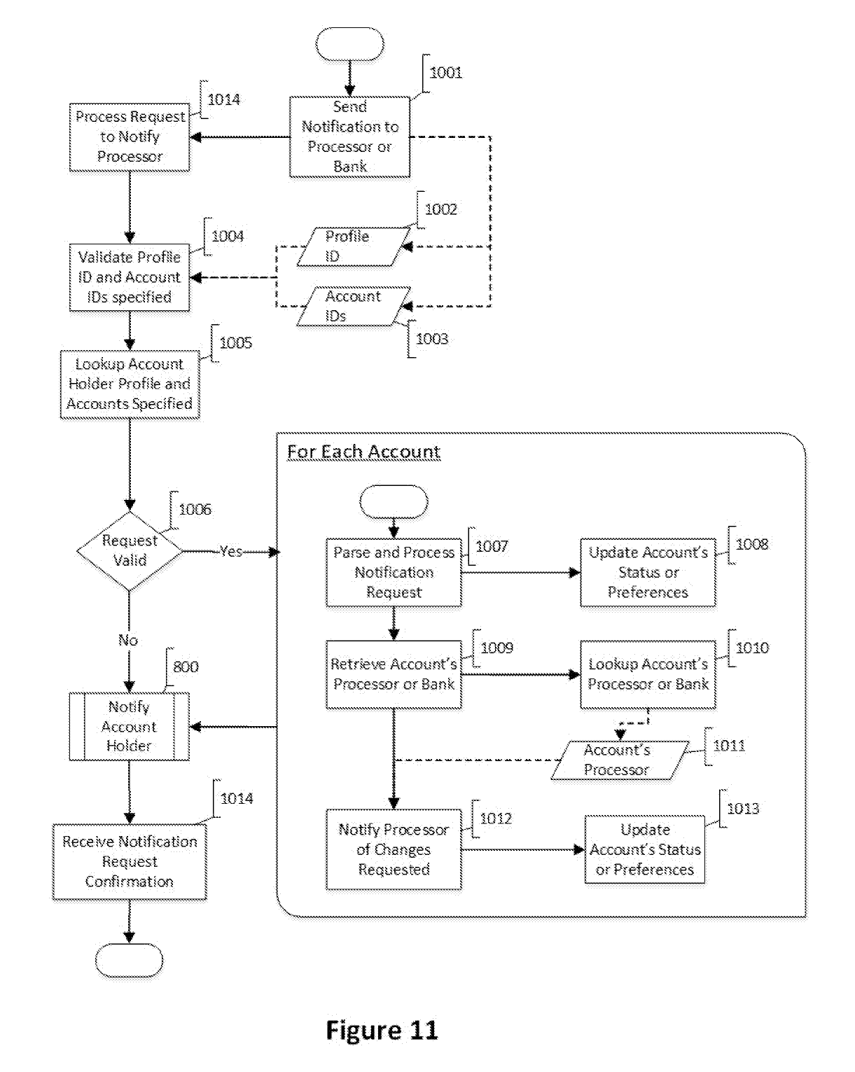

FIG. 11 illustrates steps in sub-process 1000 with respect to notifications sent to payment processors and related financial institutions, which is somewhat similar to the sub-process 900 in FIG. 10.

Beyond requests to lock or unlock accounts, the account holder 5 may, for example, wish to notify one of its relevant payment processors that a corresponding payment card has been lost or stolen, or to indicate beforehand that the account holder 5 will have international travel plans (so that fraud analyses can be adjusted accordingly). In another example, the account holder 5 may wish to communicate a request for, for example, a new checkbook for a checking account, or for a replacement payment card if the card has been damaged.

The sub-process 1000 initiates when account holder 5 submits a request or other communication 1001, along with a profile ID 1002 and one or more account IDs 1003 for the accounts in question. The central application server 3 processes the request 1001 at 1003, and validates the request (using the user and account IDs) at 1004. Once validated, the account holder profile is looked up at the central database 1 at 1005.

When the notification request 1001 is validated at 1006, the process iterates through each Account requested (as indicated by the group of steps across the central application server 3, the central database 1, and the processor's database server 6, and labeled “For Each Account”) and identified to update or schedule their status or preferences. An Account ID could be a number or alphanumeric word or phrase given by the account holder 5 to let the system identify Accounts in the account holder's profile. The same considerations for constituting the account ID as discussed above in FIG. 10 apply here.

For each account specified, the central application server 3 invokes at step 1007 a process at central database 1 to change the status of the account (step 1008) in the manner requested by the account holder 5. At step 1009, central application server 3 requests the payment processor or bank corresponding to the account in question, which corresponds with a lookup step 1010 at the central database 1 to obtain the relevant payment processor 1011. Once the relevant payment processor 1011 for the account in question is identified, the central application server 3 sends a request 1012 to the payment processor's database server 6 to update the account's status (see step 1013).

The account holder 5 is then notified (using the notification sub-process 800) of the result(s) of the requested operation(s), and receives in due course a confirmation 1014 that the request has been carried out.

Finally, FIG. 12 illustrates the steps of sub-process 1100 (validate transaction details) as mentioned in, for example, sub-process 500 (FIG. 6, above), relative to the transaction authorization.

When sub-process 500 originates in the processor's security code database 4, or when a transaction's details need to be validated against any applicable rules previously established in the account holder's enrollment profile, this sub-process 1100 to validate the transaction details is run at the processor's security code database 4.

Given a profile ID 1101, the account holder's enrollment profile is found (1102) and a determination is made if there are any account holder-established transaction rules that apply (1103). If there are no applicable transaction rules, the sub-process 1100 exits indicating that the transaction details process has “passed” (i.e., is complete).

Otherwise, the applicable rules (e.g., transaction amounts/limits 1106, merchant-related details (such as merchant name, or any applicable commercial merchant category code) 1107, recurring transaction flag/indicator 1108, or any other transaction-related details 1109, such as local transaction date and time, and product or service purchased information) are run through and validated as applicable at 1105, using transaction details received as input to this sub-process, typically from the payment processor processing the transaction authorization sub-process 500.

In further detail, examples of transaction validation rules as contemplated here include, without limitation:

Transaction Amount limits: The account holder 5 may pre-define a maximum or top limit for any given transaction attempted on a registered Account. For example, an account holder may want to decline any transaction attempt over, for example, $500.00 on a given Credit Card registered in the account holder's enrollment profile.

Merchant or Merchant Category restrictions: The account holder may choose to bar transactions for certain Merchants or Merchant Categories, if attempted. Conversely, the account holder could specify that one or more of his accounts can only be used at certain specific merchants, or for certain merchant categories. The account holder could also specify a list of Merchants or Merchant Categories for which a registered Account is to be exclusively used at, and decline any transactions attempted at any other Merchant or Merchant Category. For example, an Account holder may choose for an Account to be used and approved only to purchase certain items, or at certain locations or merchant categories, like groceries or gas, or may want to limit certain merchant categories such as decline any purchases attempted at liquor stores for instance.

Recurring Transactions Rules: An account holder may decide whether to approve or decline recurring transactions from certain merchants or billers, or specify how many recurring transactions should be approved and with what frequency. The account holder may elect for all recurring transactions to be declined for a registered Account, unless specified on the Transaction Validation Rules setup on the account holder's enrollment profile. For example, an account holder may specify that an Account should only accept recurring transactions from a specific Electric Company, quarterly, for an amount not higher than $1200.00, and from a specific Cable TV Provider, monthly, for $150.00 or less. The account holder may setup these rules to be active until removed, or specify an expiration date, or number of installments to be approved.

Other rules or any combination of these could also be specified. For instance, the Recurring Transactions Rules may include Merchant Category limits, or Transaction Amount maximum.

After the transaction validation rules are checked at 1105, if the transaction passes all of the applicable rules at 1110, the process returns a “pass” result at 1104. Otherwise, it returns a “fail” result 1111, and additionally the account holder may be optionally informed for the validation failure via notification sub-process 800.

A variation of this implementation could also involve real-time communication with the account holder in the case where the rules validation fail, in order to let the account holder actively participate in the transaction approval process. For instance, if a recurring ACH payment is received and the account holder has not setup rules for this particular type of payment, then the account holder could be notified through an automated or live-agent phone call, or SMS text message, or Mobile Application Push Notification for example, in order to request approval or confirm decline from the account holder, and possibly setup the Recurring Transaction Rules at that point for any other transaction attempt from this particular Payee or Biller. Other real-time communications with the account holder could also take place during a transaction authorization request, in most cases during the processing of offline transactions such as Check or ACH payments, in order for instance to let the account holder rectify an invalid security code having been entered.

Although the present invention is described above with reference to certain particular examples for the purpose of illustrating and explaining the invention, it must be understood that the invention is not limited solely with reference to the specific details of those examples. More particularly, the person skilled in the art will readily understand that modifications and developments can be carried out in the preferred embodiments.

Although the invention is described above in the context of electronic payment transactions, the disclosed concept can be more generally applied to secured electronic access to sensitive electronic networks or other electronic entities requiring user authentication that reduces exposure of an underlying security code. For example, the present invention can be applied to user authentication in dealing with tax authorities to permit user authentication at the time of filing a tax return or interacting with the tax authorities with regard to issues like refunds and the like. More generally, it could permit a user to conveniently use a single security code to interact with a plurality of, for example, governmental agencies (taxation, licensing, law enforcement, etc.) in the same way that use with a plurality of financial entities was described above. It could be contained and run remotely from the entity being accessed (accessed for example via an API), and would receive, for example, a profile ID, a requester ID (corresponding to the entity that the user is seeking to access, and analogous in the foregoing description to a payment processor identification), the requester's password, and the security code being submitted by a user.

Although the present invention is described above with reference to certain particular examples for the purpose of illustrating and explaining the invention, it must be understood that the invention is not limited solely with reference to the specific details of those examples. More particularly, the person skilled in the art will readily understand that modifications and developments that can be carried out in the preferred embodiments without thereby going beyond the ambit of the invention.

What is claimed is:

1. A method of using a limited-life security code to permit a financial entity to authenticate an electronic payment transaction, comprising:
receiving a previously-established matrix associating a plurality of users with respective unique sets of security codes, the security codes of each set each having a time period of validity;
receiving a request to process an electronic payment transaction, the request including a security code for authentication, the received security code being allegedly associated with one of the plurality of users;
comparing the received security code with the security code in the previously-established matrix held by the financial entity corresponding to the alleged one of the plurality of users for the time period of validity corresponding to the time of the request to process the electronic payment transaction; and
approving or disapproving the transaction depending on the correspondence between the received security code and the corresponding security code in the matrix for the corresponding time period of validity or lack thereof.

2. The method of claim 1, wherein the limited-life security code is common to a plurality of modes of electronic payment belonging to the user.

3. The method of claim 2, wherein the user's payment modes comprise one or more of checking accounts, credit card accounts, automated clearing house transactions, debit card accounts, prepaid credit card accounts, gift card accounts, and check not present payments.

4. The method of claim 2, wherein a plurality of financial entities corresponding to the plurality of modes of payment are each provided with the same matrix of security codes so that a given security code for the user can be used with all of the user's modes of payment in a given time period of validity.

5. The method of claim 4, comprising hashing the codes in each matrix of security codes using a hash salt unique to a given one of the plurality of financial entities, prior to the matrix being received by the given one of the financial entities.

6. The method of claim 5, further comprising hashing the received security code using the same hash salt as that used to hash the matrix of security codes, such that comparing the received security code with the corresponding security code in the previously-established matrix comprises comparing the hashed received security code with the hashed security code in the matrix for that user and for the relevant time period of validity.

7. The method of claim 1, wherein each security code in the matrix is generated by a random number generator.

8. The method of claim 1, wherein the time period of validity is one calendar day.

9. The method of claim 1, further comprises conveying the security code for a current time period of validity to the user.

10. The method of claim 1, wherein a current security code may be selectively invalidated.

11. The method of claim 1, wherein a current security code may be selectively replaced prior to the end of its validity period, resulting in generation of a new matrix of hashed security codes including the replaced security code for the still-pending validity period.

12. The method of claim 2, wherein one or more of the user's modes of payment can be selectively locked and unlocked from use by:
receiving a lock/unlock request from the user, evidence of the user's identity, and the mode or modes of payment to be locked/unlocked;
informing the financial institution and/or payment processor associated with each mode or modes of payment of a new locked or unlocked status; and
confirming the locking or unlocking with the user.

13. The method according to claim 1, further comprising applying pre-defined transaction approval rules to a given transaction in addition to authentication of the user's security code.

14. The method according to claim 13, wherein the transaction approval rules comprise one or more of: limits on transaction amounts; restrictions on transactions with specific merchants or merchant categories; and restrictions on recurring transactions.

15. A method of generating and distributing limited-life security codes for user authentication in an electronic payment transaction, comprising:
associating a plurality of users with respective unique pattern identifications;
generating a set of random number security codes for each pattern identification, each security code in each set corresponding to a different time period of validity to thereby obtain a matrix associating the plurality of users with respective sets of security codes, each security code corresponding to a respective time period of validity;
conveying the matrix to respective payment processors associated with at least one mode of payment of at least one of the plurality of users in the matrix; and
conveying at least a currently valid security code to each of the users for use in authentication of electronic payment transactions, wherein the authentication comprises comparing a security code submitted by a user as part of an electronic payment transaction with the security code in the matrix for that user and for the relevant time period of validity relative to the time of the electronic payment transaction.

16. The method according to claim 15, wherein time period of validity of the security codes is measured in days, hours, or days and hours.

17. The method according to claim 15, wherein the time period of validity of the security codes is one day.

18. The method according to claim 15, wherein conveying at least a currently valid security code comprises conveying the currently valid security code and one or more security codes which will be subsequently valid.

19. The method according to claim 15, wherein conveying at least a currently valid security code comprises one or more of conveying at least a currently valid security code upon user request and pushing out at least a currently valid security code.

20. The method according to claim 15, wherein the at least one mode of payment comprises one or more of checking accounts, credit card accounts, automated clearing house transactions, debit card accounts, prepaid credit card accounts, gift card accounts, and check not present payments.

21. The method according to claim 15, wherein generating a set of random number security codes comprises generating a respective security code for each of the plurality of users for a given time period of validity, before generating a respective security code for each of the plurality of users for a subsequent time period of validity.

22. The method according to claim 15, wherein the different time periods of validity are temporally sequential.

23. The method according to claim 22, wherein there is a temporal overlap between the end of a time period of validity for a first security code, and the beginning of the time period of validity for a second subsequent security code.

24. The method according to claim 15, wherein the matrix is hashed prior to conveying the matrix to the respective payment processors, using respective hash salts that are unique to the respective payment processors.

25. A method of generating and managing a plurality of sets of limited-life and user-specific security codes for permitting a respective user to interact with a plurality of electronic entities using a single respective security code, comprising:
generating a plurality of random numbers of a predetermined digit length using a random number generator;
populating a matrix of a plurality of respective sets of the security codes using the respective generated random numbers, wherein each security code in each set of security codes is associated with a respective period of validity in the matrix and each set of security codes has a unique identifier;
associating a respective set of the security codes with a respective user;
generating a copy of the matrix of security codes for each of the plurality of electronic entities using the security codes for permitting interaction therewith and mathematically hashing the security codes in each copy using a different and unique hash salt corresponding to each of the plurality of electronic entities, thereby obtaining a plurality of uniquely hashed versions of the matrix of security codes;
conveying the respective uniquely hashed versions of the matrix of security codes to the respective electronic entities, and separately communicating the corresponding hash salt to the respective electronic entities; and
conveying at least a currently valid security code in the set of security codes associated with a respective user to that user.

26. The method according to claim 25, wherein the electronic entities including one or more of banking entities, payment processor entities, and secure computer networks.

27. The method according to claim 25, wherein a secure hashing algorithm is used to hash the random numbers in the matrix.

28. The method according to claim 25, wherein the time period of validity of each security code is a preselected 24-hour calendar day.

29. The method according to claim 25, wherein the time periods of validity of the respective security codes in a respective set are temporally sequential.

30. A method of using a limited-life security code to permit a financial entity to authenticate an electronic payment transaction, comprising:
receiving a previously-established matrix associating a plurality of users with respective unique sets of security codes, the security codes of each set each having a time period of validity, wherein each security code is mathematically hashed with a unique hash salt uniquely corresponding to a given matrix;
receiving a request to process an electronic payment transaction, the request including a security code for authentication, the received security code being allegedly associated with one of the plurality of users;
hashing the received security code using the same hash salt associated with the received matrix;
comparing the hashed received security code with the hashed security code in the previously-established matrix held by the financial entity corresponding to the alleged one of the plurality of users for the time period of validity corresponding to the time of the request to process the electronic payment transaction; and
approving or disapproving the transaction depending on the correspondence or lack of correspondence between the hashed received security code and the corresponding hashed security code in the matrix for the corresponding time period of validity.

31. The method of claim 30, wherein the matrix is populated using a random number generator to generate a plurality of random numbers of predetermined digit length.

32. The method of claim 31, wherein the random number generator is a true random number generator.
